(19) United States
(12) Patent Application Publication
(10) Pub. No.: US 2026/0190120 A1
(43) Pub. Date: Jul. 2, 2026

(54) PHYSICAL DOWNLINK CONTROL CHANNEL (PDCCH) ORDER ENHANCEMENT FOR WIRELESS COMMUNICATION

(71) Applicant: Telefonaktiebolaget LM Ericsson (publ), Stockholm (SE)

(72) Inventors: Claes TIDESTAV, Bålsta (SE); Shiwei GAO, Nepean (CA); Jianwei ZHANG, Solna (SE); Venkatarao GONUGUNTLA, Sundbyberg (SE); Siva MURUGANATHAN, Stittsville (CA)

(21) Appl. No.: 19/127,341

(22) PCT Filed: Nov. 7, 2023
(86) PCT No.: PCT/IB2023/061243

§ 371 Date: May 5, 2025

Related U.S. Application Data
(60) Provisional application No. 63/423,315, filed on Nov. 7, 2022.

(51) Int. Cl. H04W 72/232; H04W 74/0833

(52) U.S. Cl. CPC H04W 72/232; H04W 74/0833

(57) ABSTRACT

A method, system and apparatus are disclosed. A wireless device configured to communicate with at least a first TRP is provided. The wireless device is configured to receive, from the first TRP, an enhanced Physical Downlink Control Channel, PDCCH, order, where the enhanced PDCCH order initiates a random access procedure and indicating that the random access procedure is for timing advance, TA, acquisition only, cause transmission of a random access preamble in a physical random access channel, PRACH, according to the enhanced PDCCH order, monitor a physical downlink shared channel, PDSCH, for information of a TA associated to the PRACH transmission, and in response to receiving the TA carried in the PDSCH: exit the random access procedure; and apply the TA to uplink transmissions associated to the TA.

### TECHNICAL FIELD

The present disclosure relates to wireless communications, and in particular, to Physical Downlink Control Channel (PDCCH) order enhancement.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

NR uses CP-OFDM (Cyclic Prefix Orthogonal Frequency Division Multiplexing) in both downlink (DL) (i.e., from a network node to a wireless device) and uplink (UL) (i.e., from wireless device to network node). DFT spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is shown in FIG. 1 with a 14-symbol slot, where the first two symbols contain physical downlink control channel (PDCCH) and the rest contains physical shared data channel, either PDSCH (physical downlink shared channel) or PUSCH (physical uplink shared channel).

Different subcarrier spacing (SCS) values are supported in NR. The supported SCS values (also referred to as different numerologies) are given by Δf=(15×2^{μ}) kHz where μ∈{0, 1, 2, 3, 4}. Δf=15 kHz is the basic subcarrier spacing. The slot duration for a given subcarrier spacing is ½^{μ} ms.

In the frequency domain, a system bandwidth is divided into resource blocks (RBs), each corresponds to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink transmissions to a wireless device can be dynamically scheduled by sending downlink control information (DCI) with a DL DCI format on PDCCH. The DCI contains scheduling information such as time and frequency resource, modulation and coding scheme, etc. The user data are carried on PDSCH. The wireless device first detects and decodes PDCCH and if the decoding is successful, it then decodes the corresponding PDSCH according to the scheduling information in the DCI.

Similarly, uplink data transmission can be dynamically scheduled using a UL DCI format on PDCCH. A wireless device first decodes uplink grants in the DCI and then transmits data over PUSCH according to the control information contained in the uplink grant such as modulation order, coding rate, uplink resource allocation, etc.

In addition to dynamic scheduling, semi-persistent transmission of PUSCH using configured grants (CG) is also supported in NR. There are two types of CG based PUSCH defined in NR Rel-15 (i.e., 3GPP Release 15). In CG type 1, a periodicity of PUSCH transmission as well as the time domain offset are configured by RRC. In CG type 2, a periodicity of PUSCH transmission is configured by RRC and then the activation and release of such transmission is controlled by DCI, i.e., with a PDCCH.

### Time Alignment and Uplink Synchronization in NR

Different wireless devices in a cell may typically be located at different positions within the cell and then within different distances to the network node (e.g., NR gNodeB). As the wireless devices may be at different locations from the network node, if all wireless devices transmit to the network node at same time instance, transmissions from different wireless devices may reach the network node at different time instances. Unless all wireless device transmissions are received at network node at the same time or within certain reception window (e.g., within a cyclic prefix) they will interfere with each other, thereby resulting in performance degradations at the network node. In order to help ensure that the Uplink (UL) transmissions from a wireless device reach the network node within the corresponding reception window in the network node, an uplink timing control procedure is therefore used.

Time alignment of the uplink transmissions is achieved by applying a timing advance at the wireless device transmitter, relative to the received downlink timing. One role of this is to counteract different propagation delays between different wireless devices. An example is shown in FIGS. 3A and 3B, where FIG. 3A shows the DL and UL timing for two wireless devices, one physical close to the network node and the other physical far away from the network node, without applying any time advance to UL transmissions, while FIG. 3B shows the DL and UL timing of the same wireless devices after a time advance is applied to the UL transmission at each of the wireless devices. By applying a proper time advance at each of the wireless devices, the UP transmissions from the wireless devices would reach the network node at the same time or within a time window.

In order to achieve the time alignment between different wireless devices, the network node (e.g., gNodeB, eNodeB) derives the Timing Advance (TA) value that the wireless device needs to use for the UL transmissions in order to reach the network node within the receive window and indicates this to the wireless device.

### Acquiring Initial Timing Advance (TA)

A wireless device in NR typically acquires initial DL slot and symbol timing (DL timing in short) based on an SSB (Synchronization Signals and Physical Broadcast Channel Blocks) and initial UL timing based on a random access (RACH) procedure, in which the wireless device transmits a physical RACH (PRACH) preamble (Msg1 for 4-step RACH or MsgA for 2-step RACH) in a PRACH resource associated with the SSB using the DL timing as a reference and a same transmission filter or beam as the one used in receiving the SSB.

Due to round trip propagation delay, the received PRACH preamble at the network node may not be aligned with the UL slot/symbol expected by the network node. A timing correction is then sent from the network node to the wireless device in a RACH response message (RAR). The timing correction is referred to as a timing advance (TA), which is used to correct the wireless device UL transmission timing such that the subsequent UL channels or signals can reach the network node at the desired UL slot or symbol time. The TA is carried by a timing advance command (TAC) in the RAR. The RAR message format for MAC RAR is shown in FIG. 4.

A timing advance command in RAR indicates timing advance NTA values by index values of T_{A}=0, 1, 2, . . . , 3846, where an amount of the time alignment for a subcarrier spacing (SCS) of 2^{μ}·15 KHz is N_{TA}=T_{A}·16·64/2^{μ} T_{c}, where, Δfₘₐₓ=480·103 Hz, and

In some scenario, the UL and DL slot timing may be shifted intentionally by a configurable time offset, N_{TA,offset}. In that case, N_{TA} is applied in addition to the fixed timing advance offset N_{TA,offset}, i.e., the total applied timing advance is N_{TA,offset}+N_{TA}.

A RACH procedure can be initiated by either the network node or wireless device. The RACH procedure can be contention based (CB) or contention free (CF). A RACH procedure can be initiated by the network node via a PDCCH order carried by a DCI format 1_0 in NR. According to 3GPP standards such as, for example, 3GPP Technical Specification (TS) 38.212, if the CRC of the DCI format 1_0 is scrambled by C-RNTI and the “Frequency domain resource assignment” field are of all ones, the DCI format 1_0 is for random access procedure initiated by a PDCCH order, with all remaining fields are set as follows:
Random Access Preamble index—6 bits according to ra-PreambleIndex in 3GPP standards such as, for example, Clause 5.1.2 of 3GPP TS 38.321.
UL/SUL indicator—1 bit. If the value of the “Random Access Preamble index” is not all zeros and if the wireless device is configured with supplementaryUplink in ServingCellConfig in the cell, this field indicates which UL carrier in the cell to transmit the PRACH according to 3GPP standards such as, for example, Table 7.3.1.1.1-1 in 3gpp TS38.212; otherwise, this field is reserved.
SS/PBCH index—6 bits. If the value of the “Random Access Preamble index” is not all zeros, this field indicates the SS/PBCH that is be used to determine the RACH occasion for the PRACH transmission; otherwise, this field is reserved.
PRACH Mask index—4 bits. If the value of the “Random Access Preamble index” is not all zeros, this field indicates the RACH occasion associated with the SS/PBCH indicated by “SS/PBCH index” for the PRACH transmission, according to 3GPP standards such as, for example, Clause 5.1.1 of 3GPP TS38.321; otherwise, this field is reserved.
Reserved bits—12 bits for operation in a cell with shared spectrum channel access in frequency range 1 or when the DCI format is monitored in common search space for operation in a cell in frequency range 2-2; otherwise 10 bits.

After receiving a PDCCH order, the wireless device transmits PRACH according to the information provided in the PDCCH order. When the PRACH preamble index is non-zero, a contention free RACH (CFRA) procedure is triggered, in which the PRACH preamble is allocated only for the wireless device in a corresponding PRACH resource, and the information is known to both the network node and the wireless device. Otherwise, a contention-based RACH (CBRA) procedure is triggered by the PDCCH order, in which the wireless device selects a PRACH preamble randomly from a set of PRACH preambles and the same preamble could be selected by more than one wireless devices in a same PRACH resource.

### Uplink Time Alignment Maintenance

In carrier aggregation (CA), a wireless device may be configured with multiple serving cells, some of the cells may not be co-located and different TAs may be needed for UL transmissions to those cells. To inform the wireless device about that, timing advance group (TAG) was introduced. For cells that are co-located and can share a same TA value, they belong to a same TAG and can be configured with a same TAG identifier or index (ID). For cells that are not co-located and need different TAs, they can be 10 configured in different timing advance groups.

After the wireless device is configured with its serving cell(s) for a given cell group (e.g., Master Cell Group—MCG and/or Secondary Cell Group—SCG), the wireless device obtains the initial timing advance, TA, value via random access response (RAR), and is configured with the association between serving cells and TAG identifiers, the wireless device may need to maintain the time alignment according to the TA procedure defined in 3GPP standards such as in, for example, Clause 5.2 in TS 38.321.

Except initial TA, which is carried in a RACH response message, regular TAs during time maintenance are carried in a timing advance command MAC CE as shown in FIG. 5 (which is based on information taken from 3GPP TS 38.321), where it consists of
TAG Identity (TAG ID): This field indicates the TAG Identity of the addressed TAG. The TAG containing the SpCell (i.e., a special cell which can be a primary cell in MCG or SCG, where a primary cell supports PUCCH transmission and contention-based Random Access, and is always activated) has the TAG Identity 0. The length of the field is 2 bits;
Timing Advance Command: This field indicates the index value T_{A} (0, 1, 2 . . . 63) used to control the amount of timing adjustment that MAC entity has to apply (as specified in 3GPP standards such as in, for example, 3GPP TS 38.213). The length of the field is 6 bits.

For a SCS of 2^{μ}·0.15 kHz, the timing advance command, T_{A}, for a TAG indicates the change of the uplink timing relative to the current uplink timing for the TAG in multiples of 16·64·T_{c}/2^{μ}.

A timing advance command, T_{A}, for a TAG indicates adjustment of a current N_{TA} value, N_{TA_old}, to the new N_{TA} value, N_{TA_new}, by index values of T_{A}=0, 1, 2, . . . , 63, where for a SCS of 2^{μ}·15 kHz, N_{TA_new}=N_{TA_old}+(T_{A}−31)·16·64/2^{μ T}_{c}.

In addition, in some scenarios, the network node may send an absolute timing advance command via MAC CE to the wireless device as shown below, where “R” bit fields are reserved. In this case, timing advance NTA values are indicated by index values of T_{A}=0, 1, 2, . . . , 3846, where an amount of the time alignment for a subcarrier spacing (SCS) of 2^{μ}·15 kHz is N_{TA}=T_{A}·16·64/2^{μ} T_{c}. FIG. 6 is a diagram of an absolute timing advanced command MAC CE.

According to 3GPP standards such as, for example, 3GPP TS38.213, upon reception of a timing advance command for a TAG, the wireless device adjusts uplink timing for PUSCH/SRS/PUCCH transmission on all the serving cells in the TAG based on a value N_{TA,offset} that the wireless device expects to be same for all the serving cells in the TAG and based on the received timing advance command where the uplink timing for PUSCH/SRS/PUCCH transmissions is the same for all the serving cells in the TAG.

For time alignment maintenance purpose, a time alignment timer per TAG is used to control how long the Medium Access Control (MAC) entity considers the Serving Cells belonging to the associated TAG to be uplink time aligned. The time Alignment Timer thus indicates a time duration within which the wireless device may consider a received TA value as valid. If the wireless device does not receive an updated value before the time Alignment Timer expires, the wireless device is no longer UL synchronized to the serving cells belonging to the corresponding TAG.

Upon reception of the Timing Advance Command (which is a MAC Control Element, or MAC CE), the wireless device applies the timing advance indicated in the command if the time alignment timer is still running and the timer is started or re-started.

When the time alignment timer expires, the following procedure is specified in 3GPP standards such as in, for example, 3GPP TS 38.321 where a PTAG (primary TAG) is a TAG containing the SpCell of a MAC entity and a STAG (secondary TAG) is a TAG containing cells other than a primary cell.
if the time Alignment Timer is associated with the PTAG:
   flush all HARQ buffers for all Serving Cells;
   notify RRC to release PUCCH for all Serving Cells, if configured;
   notify RRC to release SRS for all Serving Cells, if configured;
   clear any configured downlink assignments and configured uplink grants;
   clear any PUSCH resource for semi-persistent CSI reporting;
   consider all running time Alignment Timers as expired;
   maintain N_{TA} of all TAGS.
else if the time Alignment Timer is associated with a STAG, then for all Serving Cells belonging to this TAG:
   flush all HARQ buffers;
   notify RRC to release PUCCH, if configured;
   notify RRC to release SRS, if configured;
   clear any configured downlink assignments and configured uplink grants;
   clear any PUSCH resource for semi-persistent CSI reporting;
   maintain N_{TA} of this TAG.

The MAC entity may not perform any uplink transmission on a Serving Cell except the Random Access Preamble when the time Alignment Timer associated with the TAG to which this Serving Cell belongs is not running. Furthermore, when the time Alignment Timer associated with the PTAG is not running, the MAC entity may not perform any uplink transmission on any Serving Cell except the Random Access Preamble on the SpCell. Further details of the maintenance procedure can be found in 3GPP standards such as in, for example, 3GPP TS 38.321

### PRACH Procedure

Physical random access procedure can be triggered upon request of a PRACH transmission by a PDCCH order. A configuration by higher layers for a PRACH transmission includes the following:
A configuration for PRACH transmission (further details are in 3GPP standards such as in, for example, 3GPP TS 38.211).
A preamble index, a preamble SCS, PPRACH, target, a corresponding RA-RNTI, and a PRACH resource.

A PRACH is transmitted using the selected PRACH format with transmission power P_{PRACH,b,f,c}(i), as described in 3GPP standards such as in, for example, clause 7.4 of 3GPP TS38.213, on the indicated PRACH resource.

For contention free PRACH, a dedicated RACH configuration is provided by a higher layer parameter RACH-ConfigDedicated. A wireless device is provided with N SS/PBCH block indexes associated with one PRACH occasion by a higher layer parameter ssb-perRACH-Occasion in occasions. If N<1, one SS/PBCH block index is mapped to 1/N consecutive valid PRACH occasions. If N≥1, all consecutive N SS/PBCH block indexes are associated with one PRACH occasion.

For a PRACH transmission by a wireless device triggered by a PDCCH order, the PRACH mask index field, if the value of the random access preamble index field is not zero, indicates the PRACH occasion for the PRACH transmission where the PRACH occasions are associated with the SS/PBCH block index indicated by the SS/PBCH block index field of the PDCCH order.

In response to a PRACH transmission, a wireless device attempts to detect a DCI format 1_0 with CRC scrambled by a corresponding RA-RNTI during a window controlled by higher layers (See 3GPP standards such as 3GPP TS 38.321). The window starts at the first symbol of the earliest CORESET that the wireless device is configured to receive PDCCH for Type1-PDCCH CSS set, as defined in 3GPP standards such as in, for example, clause 10.1 of 3GPP TS 38.213, that is at least one symbol, after the last symbol of the PRACH occasion corresponding to the PRACH transmission. The length of the window in number of slots, based on the SCS for Type1-PDCCH CSS set, is provided by ra-ResponseWindow.

If the wireless device detects the DCI format 1_0 with CRC scrambled by the corresponding RA-RNTI and LSBs (List Significant Bits) of a SFN (System Frame Number) field in the DCI format 1_0, if included and applicable, are the same as corresponding LSBs of the SFN where the wireless device transmitted PRACH, and the wireless device receives a transport block in a corresponding PDSCH within the window, the wireless device passes the transport block to higher layers. The higher layers parse the transport block for a random access preamble identity (RAPID) associated with the PRACH transmission. If the higher layers identify the RAPID in RAR message(s) of the transport block, the higher layers indicate an uplink grant to the physical layer. This is referred to as random access response (RAR) UL grant in the physical layer.

If the wireless device does not detect the DCI format 1_0 with CRC scrambled by the corresponding RA-RNTI within the window, or if the wireless device detects the DCI format 1_0 with CRC scrambled by the corresponding RA-RNTI within the window and LSBs of a SFN field in the DCI format 1_0, if included and applicable, are not same as corresponding LSBs of the SFN where the wireless device transmitted PRACH, or if the wireless device does not correctly receive the transport block in the corresponding PDSCH within the window, or if the higher layers do not identify the RAPID associated with the PRACH transmission from the wireless device, the higher layers can indicate to the physical layer to transmit a PRACH.

### Multi-DCI Scheduling

In NR Release 16, multi-DCI based DL and UL scheduling was introduced, in which a wireless device may receive two DCI formats, a first and a second DCI formats, carried by two PDCCHs, a first and a second PDCCHs, in two CORESETs, a first and a second CORESETs, respectively, in a slot. The first and second CORESETs are associated with a first and a second CORESET pool indices. The first and second DCI formats schedule a first and a second PDSCHs transmitted from a first and a second two transmission and reception points, TRPs, respectively. The two TRPs can belong to a same serving cell or different cells. It is assumed that the time difference between the two TRPs are very small and within the cyclic prefix (CP) so that a common DL and UL timing is used for both TRPs.

An example is shown in FIG. 7, where PDCCH 1 in CORESET 1 with CORESET pool index=0 scheduling PDSCH1 from TRP1 while PDCCH 2 in CORESET 2 with CORESET pool index=1 scheduling PDSCH2 from TRP2. The two PDSCHs may be fully, partially or non-overlapping in time. The HARQ-ACK associated with PDSCH1 and PDSCH2 are carried in PUCCH1 and PUCCH2, respectively, which are non-overlapping in time and are transmitted towards TRP1 and TRP2, respectively.

Similarly, a PUSCH towards TRP1 can be scheduled by a DCI format carried in a PDCCH in CORESET 1 and a PUSCH towards TRP2 can be scheduled by a DCI format carried in a PDCCH in CORESET 2. An example is shown in FIG. 8, where PDCCH 3 in CORESET 1 with CORESET pool index=0 scheduling PUSCH1 from TRP1 while PDCCH 4 in CORESET 2 with CORESET pool index=1 scheduling PUSCH2 from TRP2. PUSCH1 and PUSH2 are non-overlapping in time.

For multi-DCI multi-TRP operation, a wireless device needs to be configured with two CORESET pools, each associated with a TRP. Each CORESET pool is a collection of CORESETs configured with a same CORESET pool index.

In case that TRPs belong to a different cell with a different PCI (Physical Cell Identifier), PCI is included in the TCI states associated to the TRP. In addition, SSBs associated to the PCI are configured to the wireless device.

In NR Rel-18, two TAs, one for each TRP, are to be supported for multi-DCI based uplink transmissions towards two TRPs in a same serving cell, where a large time difference between the two TRPs may exist. For UL transmissions to different TRPs, different timing advances are applied such that the received UL signals at each intended TRP are time aligned.

For this purpose, it has been discussed that a serving cell can be configured with two TAGs, one associated to each TRP. A separate timing alignment timer would be associated to each of the two TAGs.

One issue is how to acquire the initial TAs for the two TRPs. TRP specific PRACH triggered by PDCCH order have been proposed, in which each TRP can send a PDCCH order in a CORESET with a CORESET pool index associated to the TRP to trigger a PRACH transmission to the TRP.

Another issue is how to associate a TAC in a RAR or an absolute TAC to one of the two TAGs. One proposed solution is to have an implicit association between a TAC in RAR and a TAG. For example, if a RAR is in response to a PDCCH order scheduled by a DCI in a coreset associated with TAG #k, then the TAC in the RAR is for TAG #k. Another proposed solution is to include a TAG ID in the PDCCH order and the corresponding RAR would be applicable to the TAG indicated in the PDCCH order. Another proposed solution is to indicate explicitly in RAR which TA or TAG that the TAC contained in the RAR is applicable.

In case of inter-cell multi-DCI, in which a second TRP is associated with a different physical cell Identifier (PCI), it has been proposed to signal RACH configuration including RACH preambles and resources associated to the PCI to the wireless device, including type-1 common search space (CSS) set configuration associated to the PCI, which is used to monitor PDCCH that scheduled RAR PDSCH.

According to an existing rule in NR, a PDCCH order transmitted in a SpCell and a PDCCH scheduling the corresponding RAR need to be transmitted with the same spatial filter. This means that when the two TRPs belong to a SpCell, a PDCCH order and the corresponding RAR need to be sent from the same TRP. This is an issue for TRP specific PRACH as it would require configuring two type-1 CSS sets, one associated with each TRP. However, type-1 CSS is cell specific and cannot be configured in a per wireless device basis.

### SUMMARY

Some embodiments advantageously provide methods, systems, and apparatuses for Physical Downlink Control Channel (PDCCH) order enhancement.

A method is proposed for acquiring initial TAs for a wireless device. The method may include one or more of the following:
Receiving a higher layer RACH configuration for a contention free random access (CFRA) from the network node. Where the configuration at least includes the PRACH preamble pool for CFRA, indication of whether retransmission is allowed for CFRA, periodicity of retransmissions if they are allowed, and the maximum number of retransmissions allowed.
Receiving a PDCCH order containing at least one field indicating it is for TA acquisition only and the number of total preamble (re) transmissions allowed.
Transmitting a PRACH according to the PDCCH order on the RACH occasion as indicated in the PDCCH order and, if the maximum number of retransmissions is more than one, incrementing the number of PRACH transmissions by one.
Starting a timer with time period of the timer as configured in the higher layer message or as a fixed value.
Monitoring for PDSCH carrying a MAC CE containing an absolute timing advance command addressed to the wireless device.
Receiving a timing advance (TA) through a control message, e.g., through MAC CE and stopping the timer and release the PDCCH order.
If the TA is not received before the timer expiry, upon the timer expiry, retransmit the PRACH in the next RACH occasion, and according to the PDCCH order if the number of retransmissions are less than maximum number of RACH transmissions configured.
If the total RACH occasions are equal to max number of RACH occasions configured, release the PDDCH order. Where releasing the PDCCH order means, not transmitting PRACH as per the PDCCH order received.

According to one aspect of the present disclosure, a wireless device configured to communicate with at least a first transmission and reception point, TRP, is provided. The wireless device comprises processing circuitry configured to: receive, from the first TRP, an enhanced Physical Downlink Control Channel, PDCCH, order, the enhanced PDCCH order initiating a random access procedure and indicating that the random access procedure is for timing advance, TA, acquisition only, cause transmission of a random access preamble in a physical random access channel, PRACH, according to the enhanced PDCCH order, monitor a physical downlink shared channel, PDSCH, for information of a TA associated to the PRACH transmission, and in response to receiving the TA carried in the PDSCH: exit the random access procedure, and apply the TA to uplink transmissions associated to the TA.

According to one or more embodiments of this aspect, the enhanced PDCCH order indicates a contention free random access preamble.

According to one or more embodiments of this aspect, the exit of the random access procedure comprises considering that the random access procedure is successfully completed.

According to one or more embodiments of this aspect, the enhanced PDCCH order comprises a field that is configured to indicate whether the PDCCH order is for TA acquisition only.

According to one or more embodiments of this aspect, the enhanced PDCCH order comprises a field that indicates a timing advanced group identifier, TAG ID.

According to one or more embodiments of this aspect, the TA is provided by a medium access control, MAC, control element, CE, carried in the PDSCH.

According to one or more embodiments of this aspect, the monitoring of the PDSCH for information of the TA comprises monitoring for downlink control information, DCI, with its cyclic redundancy check, CRC, scrambled by a radio network temporary identifier, RNTI, assigned to the wireless device, wherein the PDSCH is scheduled by the DCI.

According to one or more embodiments of this aspect, the RNTI is C-RNTI.

According to one or more embodiments of this aspect, the enhanced PDCCH order further comprise information of a downlink reference signal, DL RS, associated to the PRACH transmission.

According to one or more embodiments of this aspect, the DL RS is received from one of the first TRP or a second TRP.

According to one or more embodiments of this aspect, if the DL RS is received from the first TRP, the transmission of a random access preamble is towards the first TRP and the received TA is for uplink transmissions towards the first TRP.

According to one or more embodiments of this aspect, if the RS is received from the second TRP, the transmission of a random access preamble is towards the second TRP and the received TA is for uplink transmissions towards the second TRP.

According to one or more embodiments of this aspect, the processing circuitry is further configured to, in response to the transmission of the random access preamble, start a timer during which to monitor the PDSCH for information of the TA, and if the TA is not receive before expiration of the timer, causing retransmission of the random access preamble with a different transmit power from a previous transmit power for the random access preamble.

According to one or more embodiments of this aspect, the PDCCH order indicates a number of PRACH retransmissions allowed for acquiring the TA.

According to another aspect of the present disclosure, a network node in communication with a wireless device via at least a first transmission and reception point, TRP, is provided. The network node comprises processing circuitry configured to: cause transmission, via the first TRP and to the wireless device, of an enhanced Physical Downlink Control Channel, PDCCH, order, where the enhanced PDCCH order initiates a random access procedure and indicates that the random access procedure is for timing advance, TA, acquisition only, receive a random access preamble in a physical random access channel, PRACH, according to the enhanced PDCCH order, and in response to receiving the random access preamble, cause transmission of a TA carried in a physical downlink shared channel, PDSCH, the TA configured to: cause the wireless device to exit the random access procedure in response to receiving the TA carried in the PDSCH, and be applied to uplink transmissions associated with the TA.

According to one or more embodiments of this aspect, the enhanced PDCCH order indicates a contention free random access preamble.

According to one or more embodiments of this aspect, the exit of the random access procedure comprises considering that the random access procedure is successfully completed.

According to one or more embodiments of this aspect, the enhanced PDCCH order comprises a field that is configured to indicate whether the PDCCH order is for TA acquisition only.

According to one or more embodiments of this aspect, the enhanced PDCCH order comprises a field that indicates a timing advanced group identifier, TAG ID.

According to one or more embodiments of this aspect, the TA is provided by a medium access control, MAC, control element, CE, carried in the PDSCH.

According to one or more embodiments of this aspect, the TA in the PDSCH is associated with downlink control information, DCI, with its cyclic redundancy check, CRC, scrambled by a radio network temporary identifier, RNTI, assigned to the wireless device, wherein the PDSCH is scheduled by the DCI.

According to one or more embodiments of this aspect, the RNTI is C-RNTI.

According to one or more embodiments of this aspect, the enhanced PDCCH order further comprises information of a downlink reference signal, DL RS, associated to the PRACH transmission.

According to one or more embodiments of this aspect, the processing circuitry is further configured to cause transmission of the DL RS via one of the first TRP or a second TRP.

According to one or more embodiments of this aspect, if the DL RS is transmitted via the first TRP, the random access preamble is associated with the first TRP and the TA is for uplink transmissions towards the first TRP.

According to one or more embodiments of this aspect, if the DL RS is transmitted via the second TRP, the random access preamble is associated with the second TRP and the TA is for uplink transmissions towards the second TRP.

According to one or more embodiments of this aspect, the PDCCH order indicates a number of PRACH retransmissions allowed for acquiring the TA.

According to another aspect of the present disclosure, a method implemented by a wireless device that is configured to communicate with at least a first transmission and reception point, TRP, is provided. An enhanced Physical Downlink Control Channel, PDCCH, order is received from the first TRP, where the enhanced PDCCH order initiates a random access procedure and indicates that the random access procedure is for timing advance, TA, acquisition only. Transmission is caused of a random access preamble in a physical random access channel, PRACH, according to the enhanced PDCCH order. A physical downlink shared channel, PDSCH, is monitored for information of a TA associated to the PRACH transmission. In response to receiving the TA carried in the PDSCH: the random access procedure is exited, and the TA is applied to uplink transmissions associated to the TA.

According to one or more embodiments of this aspect, the enhanced PDCCH order indicates a contention free random access preamble.

According to one or more embodiments of this aspect, the exit of the random access procedure comprises considering that the random access procedure is successfully completed.

According to one or more embodiments of this aspect, the enhanced PDCCH order comprises a field that is configured to indicate whether the PDCCH order is for TA acquisition only.

According to one or more embodiments of this aspect, the enhanced PDCCH order comprises a field that indicates a timing advanced group identifier, TAG ID.

According to one or more embodiments of this aspect, the TA is provided by a medium access control, MAC, control element, CE, carried in the PDSCH.

According to one or more embodiments of this aspect, the monitoring of the PDSCH for information of the TA comprises monitoring for downlink control information, DCI, with its cyclic redundancy check, CRC, scrambled by a radio network temporary identifier, RNTI, assigned to the wireless device, where the PDSCH is scheduled by the DCI.

According to one or more embodiments of this aspect, the RNTI is C-RNTI.

According to one or more embodiments of this aspect, the enhanced PDCCH order further comprises information of a downlink reference signal, DL RS, associated to the PRACH transmission.

According to one or more embodiments of this aspect, the DL RS is received from one of the first TRP or a second TRP.

According to one or more embodiments of this aspect, if the DL RS is received from the first TRP, where the transmission of a random access preamble is towards the first TRP and the received TA is for uplink transmissions towards the first TRP.

According to one or more embodiments of this aspect, if the RS is received from the second TRP, the transmission of a random access preamble is towards the second TRP and the received TA is for uplink transmissions towards the second TRP.

According to one or more embodiments of this aspect, in response to the transmission of the random access preamble, a timer is started during which to monitor the PDSCH for information of the TA, and if the TA is not received before expiration of the timer, retransmission is caused of the random access preamble with a different transmit power from a previous transmit power for the random access preamble.

According to one or more embodiments of this aspect, the PDCCH order indicates a number of PRACH retransmissions allowed for acquiring the TA.

According to another aspect of the present disclosure, a method implemented by a network node that is in communication with a wireless device via at least a first transmission and reception point, TRP, is provided. Transmission is caused, via the first TRP and to the wireless device, of an enhanced Physical Downlink Control Channel, PDCCH, order, where the enhanced PDCCH order initiates a random access procedure and indicates that the random access procedure is for timing advance, TA, acquisition only. A random access preamble is received in a physical random access channel, PRACH, according to the enhanced PDCCH order. In response to receiving the random access preamble, transmission is caused of a TA carried in a physical downlink shared channel, PDSCH, the TA configured to: cause the wireless device to exit the random access procedure in response to receiving the TA carried in the PDSCH, and be applied to uplink transmissions associated with the TA; and

According to one or more embodiments of this aspect, the enhanced PDCCH order indicates a contention free random access preamble.

According to one or more embodiments of this aspect, the exit of the random access procedure comprises considering that the random access procedure is successfully completed.

According to one or more embodiments of this aspect, the enhanced PDCCH order comprises a field that is configured to indicate whether the PDCCH order is for TA acquisition only.

According to one or more embodiments of this aspect, the enhanced PDCCH order comprises a field that indicates a timing advanced group identifier, TAG ID.

According to one or more embodiments of this aspect, the TA is provided by a medium access control, MAC, control element, CE, carried in the PDSCH.

According to one or more embodiments of this aspect, the TA in the PDSCH is associated with downlink control information, DCI, with its cyclic redundancy check, CRC, scrambled by a radio network temporary identifier, RNTI, assigned to the wireless device, where the PDSCH is scheduled by the DCI.

According to one or more embodiments of this aspect, the RNTI is C-RNTI.

According to one or more embodiments of this aspect, the enhanced PDCCH order further comprises information of a downlink reference signal, DL RS, associated to the PRACH transmission.

According to one or more embodiments of this aspect, transmission is caused of the DL RS via one of the first TRP or a second TRP.

According to one or more embodiments of this aspect, if the DL RS is transmitted via the first TRP, where the random access preamble is associated with the first TRP and the TA is for uplink transmissions towards the first TRP.

According to one or more embodiments of this aspect, if the DL RS is transmitted via the second TRP, where the random access preamble is associated with the second TRP and the TA is for uplink transmissions towards the second TRP.

According to one or more embodiments of this aspect, the PDCCH order indicates a number of PRACH retransmissions allowed for acquiring the TA.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a block diagram of a NR time-domain structure with 15 kHZ subcarrier spacing;

FIG. 2 is a block diagram of a NR physical resource grid;

FIGS. 3A-B is a diagram of a timing alignment of uplink transmissions for a case without timing advance and for a case with timing advance;

FIG. 4 is a diagram of a RAR message;

FIG. 5 is a diagram of a timing advance command MAC CE;

FIG. 6 is a diagram of an absolute timing advance command MAC CE;

FIG. 7 is a diagram of an example multi-DCI based PDSCH scheduling from two TRPs;

FIG. 8 is a diagram of an example multi-DCI based PUSCH scheduling from two TRPs;

FIG. 9 is a schematic diagram of an example network architecture illustrating a communication system connected via an intermediate network to a host computer according to the principles in the present disclosure;

FIG. 10 is a block diagram of a host computer communicating via a network node with a wireless device over an at least partially wireless connection according to some embodiments of the present disclosure;

FIG. 11 is a flowchart illustrating example methods implemented in a communication system including a host computer, a network node and a wireless device for executing a client application at a wireless device according to some embodiments of the present disclosure;

FIG. 12 is a flowchart illustrating example methods implemented in a communication system including a host computer, a network node and a wireless device for receiving user data at a wireless device according to some embodiments of the present disclosure;

FIG. 13 is a flowchart illustrating example methods implemented in a communication system including a host computer, a network node and a wireless device for receiving user data from the wireless device at a host computer according to some embodiments of the present disclosure;

FIG. 14 is a flowchart illustrating example methods implemented in a communication system including a host computer, a network node and a wireless device for receiving user data at a host computer according to some embodiments of the present disclosure;

FIG. 15 is a flowchart of an example process in a network node according to some embodiments of the present disclosure;

FIG. 16 is a flowchart of another example process in a network node according to some embodiments of the present disclosure;

FIG. 17 is a flowchart of an example process in a wireless device according to some embodiments of the present disclosure;

FIG. 18 is a flowchart of another example process in a wireless device according to some embodiments of the present disclosure;

FIG. 19 is a diagram of a time alignment of uplink transmissions to two TRPs with two different timing advances according to some embodiments of the present disclosure;

FIG. 20 is a signaling diagram according to a first example according to some embodiments of the present disclosure;

FIG. 21 is a signaling diagram according to a second example according to some embodiments of the present disclosure; and

FIG. 22 is a diagram of an example of obtaining initial TA using a type 2 PDCCH order.

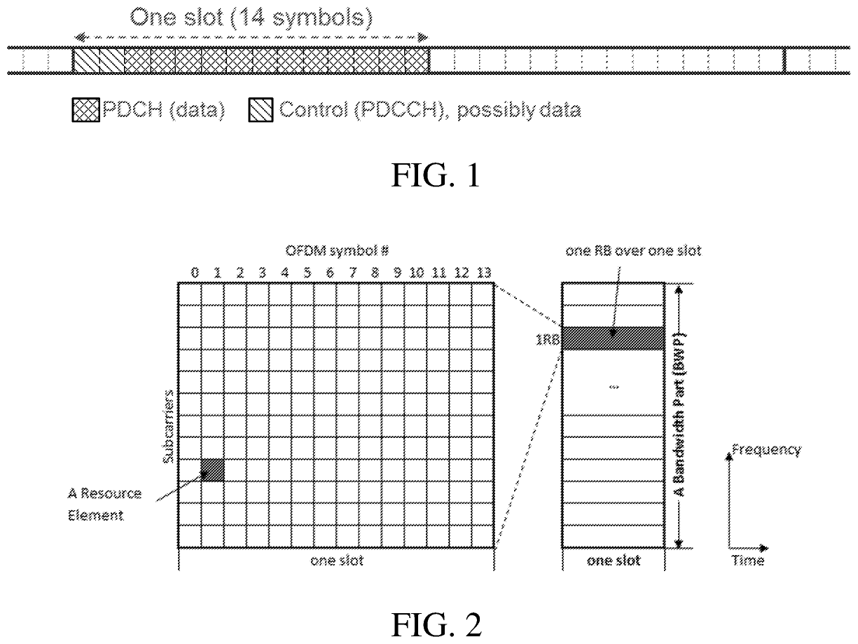

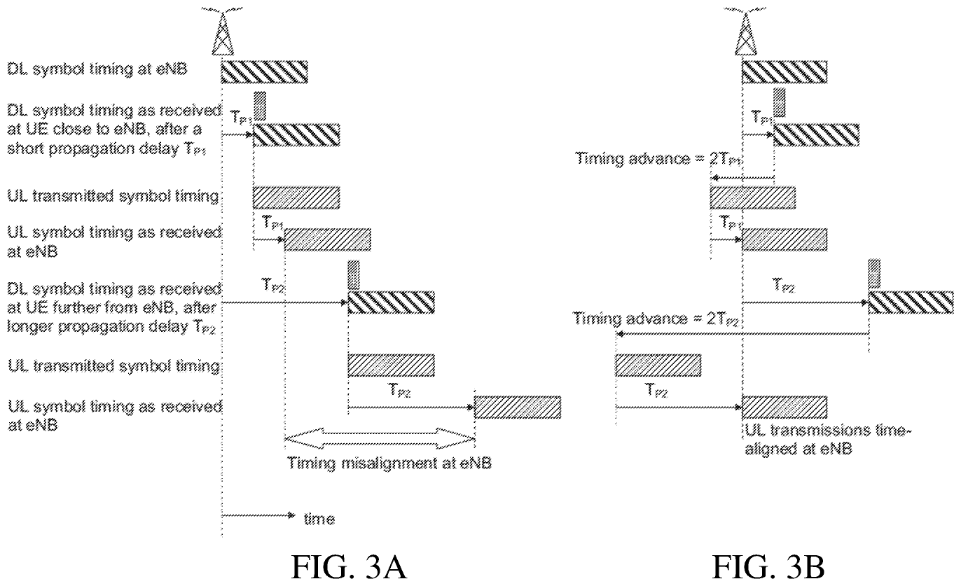

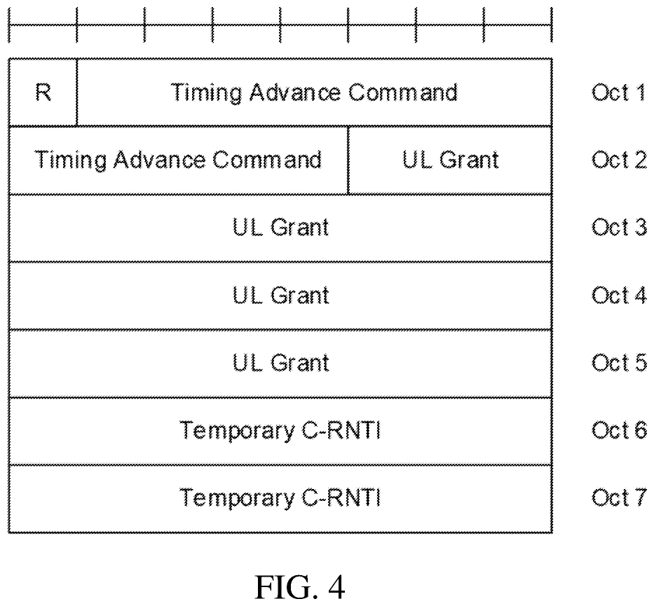

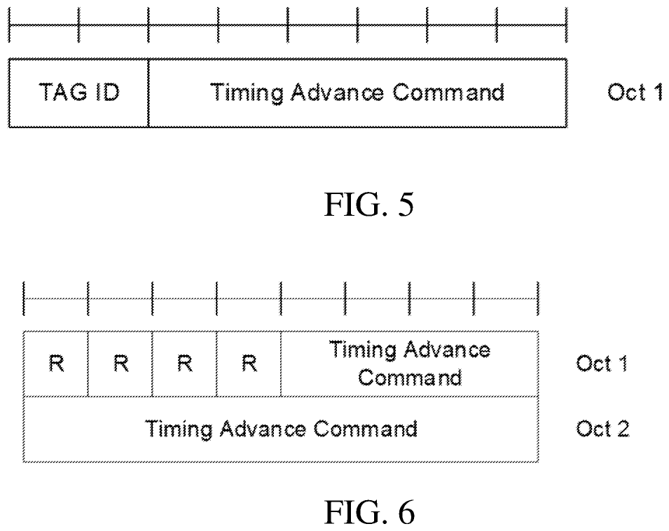

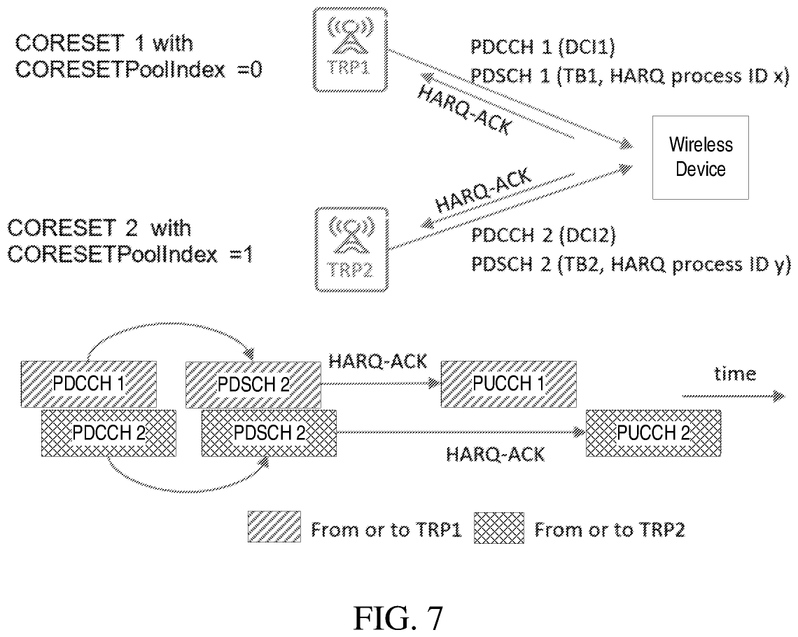

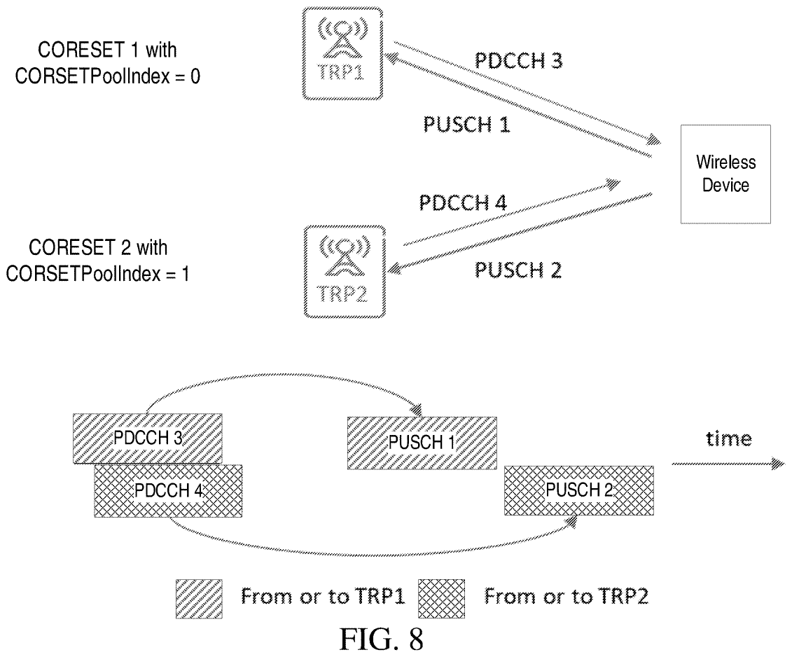

### DETAILED DESCRIPTION

In one proposed solution, methods were proposed to solve the above-mentioned problems. One of the solutions is that after sending a PRACH preamble triggered by a PDCCH order, a UE does not wait for or monitor a corresponding RACH response. Instead, the UE monitors PDSCH carrying a MAC CE containing an absolute TA command. If such a TA command is received, the wireless device considers the PRACH procedure is completed. However, PDCCH order can also be used to trigger PRACH for other purposes where a RACH response may be needed. Hence how to distinguish between a PDCCH order for acquiring TA and a PDCCH order for other purposes is an issue.

The present disclosure solves one or more of the above-mentioned problems/issues by, for example, allowing a wireless device to differentiate between a PDCCH order for TA acquisition and a PDCCH order for other purposes. The wireless device does not need to monitor for a RACH response after a PRACH transmission for acquiring a TA associated to a TAG. This is more flexible and allows a time advance command with initial TA to be sent to a wireless device from a same TRP for which a PRACH is sent to, which eliminates the need for message exchange between the two TRP, which can be slow.

Before describing in detail example embodiments, it is noted that the embodiments reside primarily in combinations of apparatus components and processing steps related to PDCCH order enhancement. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

As used herein, legacy may refer to previous and/or existing 3GPP standards while non-legacy may refer to information/configurations/etc. that have not yet been accepted into 3GPP standards.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

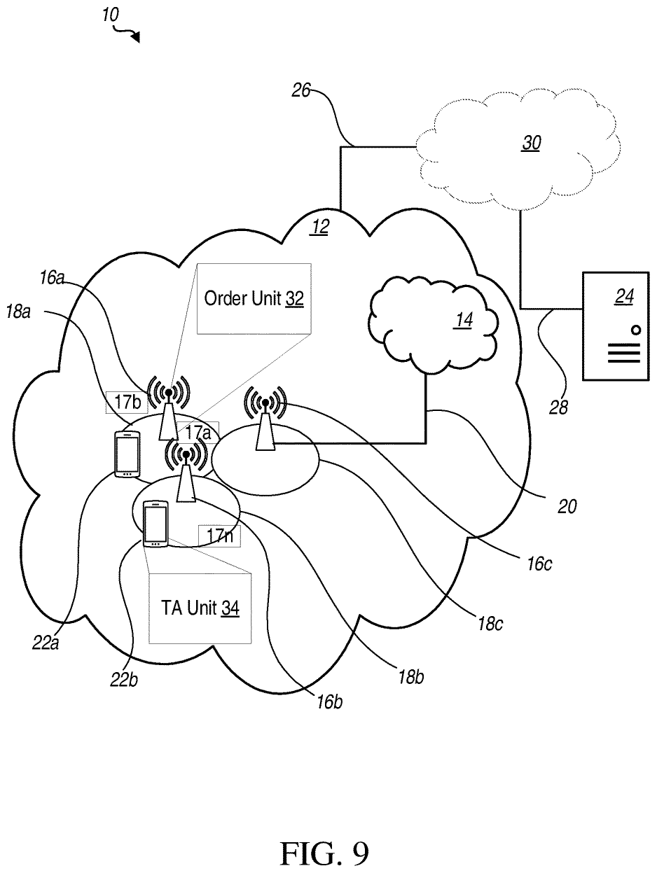

Some embodiments provide PDCCH order enhancement. Referring again to the drawing figures, in which like elements are referred to by like reference numerals, there is shown in FIG. 9 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). One or more network nodes 16 may include and/or control and/or be in communication with one or more Transmission Reception Points 17 (TRPs 17). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 9 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an order unit 32 which is configured to perform one or more network node 16 functions as described herein such as with respect to PDCCH order enhancement. A wireless device 22 is configured to include a TA unit 34 which is configured to perform one or more wireless device 22 functions as described herein such as with respect to PDCCH order enhancement.

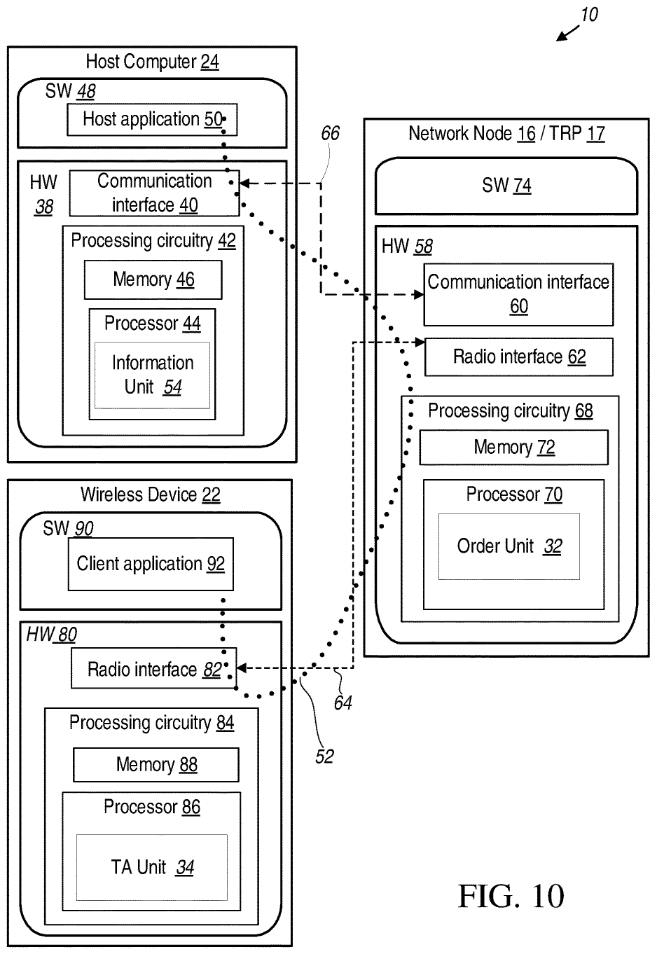

Example implementations, in accordance with an embodiment, of the WD 22, network node 16 and host computer 24 discussed in the preceding paragraphs will now be described with reference to FIG. 10. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of analyze, determine, forward, receive, transmit, relay, store, etc. information related to PDCCH order enhancement.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include order unit 32 configured to perform one or more network node 16 functions described herein such as with respect to, for example, PDCCH order enhancement.

Further, in one or more embodiments, TRP 17 may have similar and/or the same hardware 58 and/or software 74 such that TRP is able to communication with wireless device 22 and network node 16. That is, in one embodiment, network node 16 controls or is in charge of two TRPs 17 that have similar and/or the same hardware 58 and/or software 74 except that TRPs 17 may not have order unit 32. TRP 17 may be configured to communicate with wireless device 22 via radio interface 62, and with network node 16 via communication interface 60 and/or radio interface 62. In one or more embodiments, TRP 17 may be a network node 16 such that TRP 17 performs functionality of network node 16.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a TA unit 34 configured to perform one or more wireless device 22 functions described herein such as with respect to, for example, PDCCH order enhancement.

In some embodiments, the inner workings of the network node 16, WD 22, and host computer 24 may be as shown in FIG. 10 and independently, the surrounding network topology may be that of FIG. 9.

In FIG. 10, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 9 and 10 show various “units” such as order unit 32, and TA unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

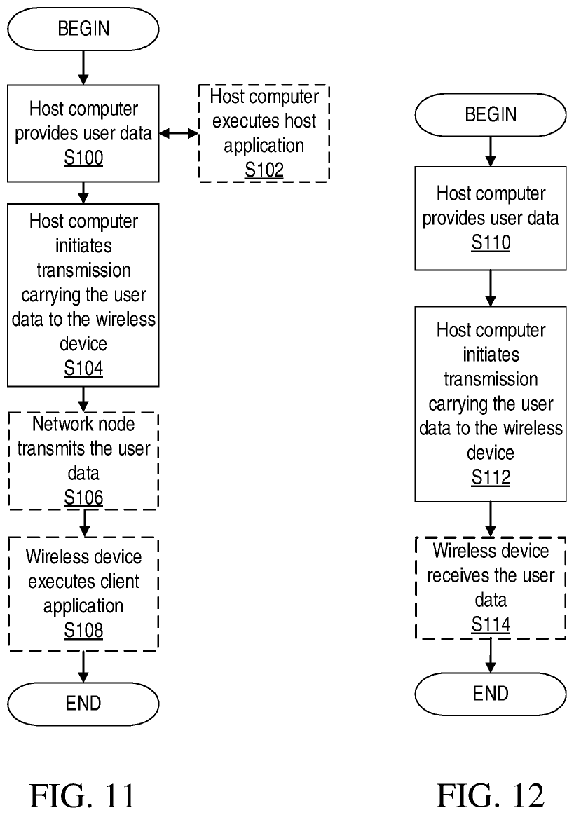

FIG. 11 is a flowchart illustrating an example method implemented in a communication system, such as, for example, the communication system of FIGS. 9 and 10, in accordance with one embodiment. The communication system may include a host computer 24, a network node 16 and a WD 22, which may be those described with reference to FIG. 10. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 12 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

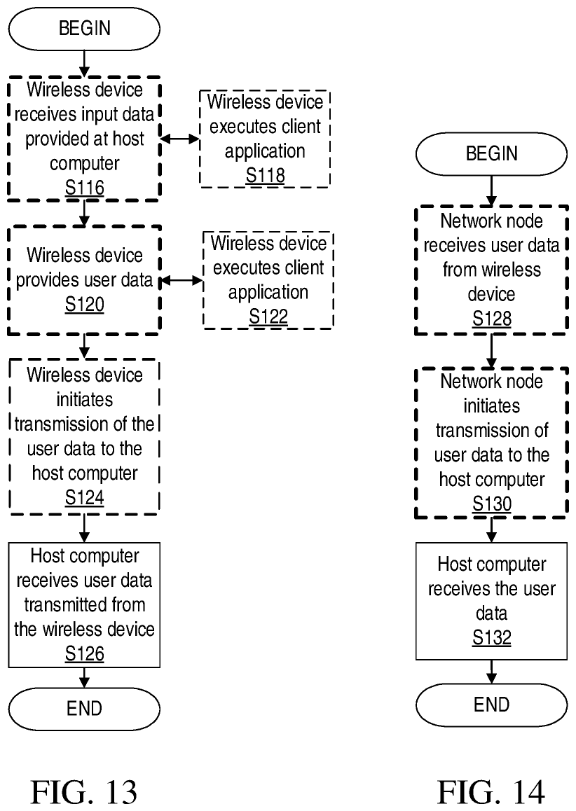

FIG. 13 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 14 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

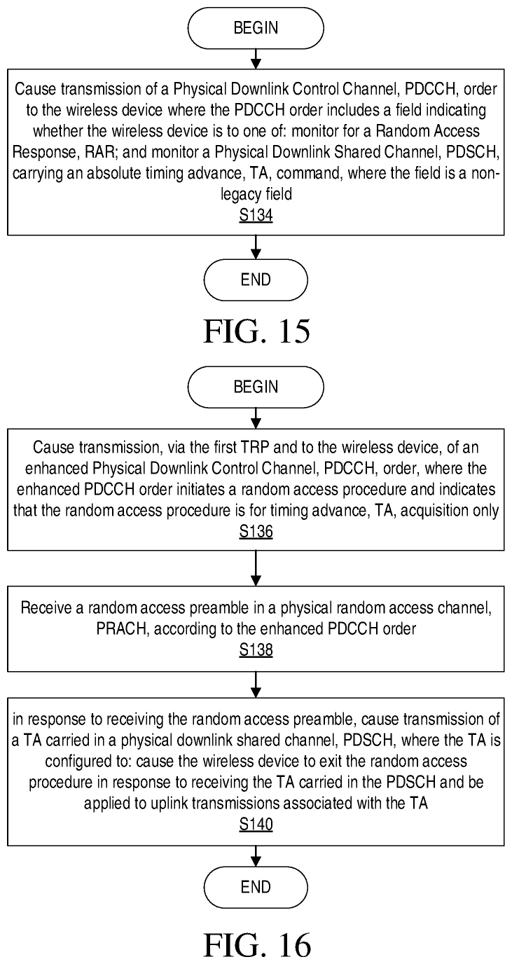

FIG. 15 is a flowchart of an example process in a network node 16 according to some embodiments of the present disclosure. One or more blocks described herein may be performed by one or more elements of network node 16 such as by one or more of processing circuitry 68 (including the order unit 32), processor 70, radio interface 62 and/or communication interface 60. Network node 16 is configured to cause transmission (Block S134) of a Physical Downlink Control Channel, PDCCH, order to the wireless device 22 where the PDCCH order includes a field indicating whether the wireless device is to one of monitor for a Random Access Response, RAR, and monitor a Physical Downlink Shared Channel, PDSCH, carrying an absolute timing advance, TA, command. The field is a non-legacy field.

According to one or more embodiments, the field is a Timing Advance Group, TAG, Identifier, ID, field. According to one or more embodiments, the indication indicates to monitor the PDSCH carrying an absolute TA command where the indication is configured to trigger a Physical Random Access Channel, PRACH, transmission, and where the PRACH transmission includes the transmission of a Contention Free Random Access, CFRA, preamble. According to one or more embodiments, the processing circuitry 68 is further configured to: estimate TA based on the CFRA preamble, and cause transmission of an absolute TA command within a Medium Access Control, MAC, Control element, CE, scheduled by a Downlink Control Information, DCI, with Cyclic Redundancy Check, CRC, scrambled by Cell-Radio Network Temporary Identifier, C-RNTI. According to one or more embodiments, the absolute TA command is specific to one of a first Transmission Reception Point, TRP 17, and a second TRP 17, the first and second TRPs 17 being in communication with the wireless device 22.

FIG. 16 is a flowchart of another example process in a network node 16 according to some embodiments of the present disclosure. One or more blocks described herein may be performed by one or more elements of network node 16 such as by one or more of processing circuitry 68 (including the order unit 32), processor 70, radio interface 62 and/or communication interface 60. Network node 16 is configured cause (Block S136) transmission, via the first TRP 17 and to the wireless device 22, of an enhanced Physical Downlink Control Channel, PDCCH, order, where the enhanced PDCCH order initiates a random access procedure and indicates that the random access procedure is for timing advance, TA, acquisition only, as described herein. Network node 16 is configured to receive (Block S138) a random access preamble in a physical random access channel, PRACH, according to the enhanced PDCCH order, as described herein. Network node 16 is configured to, in response to receiving the random access preamble, cause (Block S140) transmission of a TA carried in a physical downlink shared channel, PDSCH, the TA configured to: cause the wireless device 22 to exit the random access procedure in response to receiving the TA carried in the PDSCH and be applied to uplink transmissions associated with the TA.

According to one or more embodiments, the enhanced PDCCH order indicates a contention free random access preamble.

According to one or more embodiments, the exit of the random access procedure comprises considering that the random access procedure is successfully completed.

According to one or more embodiments, the enhanced PDCCH order comprises a field that is configured to indicate whether the PDCCH order is for TA acquisition only.

According to one or more embodiments, the enhanced PDCCH order comprises a field that indicates a timing advanced group identifier, TAG ID.

According to one or more embodiments, the TA is provided by a medium access control, MAC, control element, CE, carried in the PDSCH.

According to one or more embodiments, the TA in the PDSCH is associated with downlink control information, DCI, with its cyclic redundancy check, CRC, scrambled by a radio network temporary identifier, RNTI, assigned to the wireless device 22, wherein the PDSCH is scheduled by the DCI.

According to one or more embodiments, the RNTI is C-RNTI.

According to one or more embodiments, the enhanced PDCCH order further comprises information of a downlink reference signal, DL RS, associated to the PRACH transmission.

According to one or more embodiments, the processing circuitry 68 is further configured to cause transmission of the DL RS via one of the first TRP 17 or a second TRP 17.

According to one or more embodiments, if the DL RS is transmitted via the first TRP 17, the random access preamble is associated with the first TRP 17 and the TA is for uplink transmissions towards the first TRP 17.

According to one or more embodiments, if the DL RS is transmitted via the second TRP 17, the random access preamble is associated with the second TRP 17 and the TA is for uplink transmissions towards the second TRP 17.

According to one or more embodiments, the PDCCH order indicates a number of PRACH retransmissions allowed for acquiring the TA.

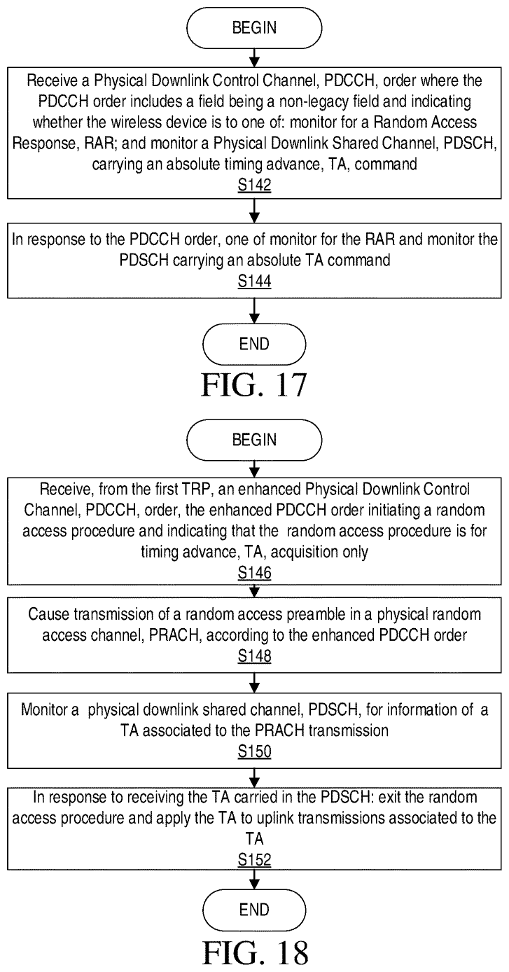

FIG. 17 is a flowchart of an example process in a wireless device 22 according to some embodiments of the present disclosure. One or more blocks described herein may be performed by one or more elements of wireless device 22 such as by one or more of processing circuitry 84 (including the TA unit 34), processor 86, radio interface 82 and/or communication interface 60. Wireless device 22 is configured to receive (Block S142) a Physical Downlink Control Channel, PDCCH, order where the PDCCH order includes a field being a non-legacy field and indicating whether the wireless device is to one of: monitor for a Random Access Response, RAR, and monitor a Physical Downlink Shared Channel, PDSCH, carrying an absolute timing advance, TA, command. Wireless device 22 is configured to, in response to the PDCCH order, one of: monitor for the RAR; and monitor the PDSCH carrying an absolute TA command (Block S144).

According to one or more embodiments, the field is a Timing Advance Group, TAG, Identifier, ID, field. According to one or more embodiments, the indication indicates to monitor the PDSCH carrying an absolute TA command where the indication is configured to trigger a Physical Random Access Channel, PRACH, transmission, and the PRACH transmission includes the transmission of a Contention Free Random Access, CFRA, preamble.

According to one or more embodiments, the processing circuitry 84 is further configured to: receive an absolute TA command within a Medium Access Control, MAC, Control element, CE, scheduled by a Downlink Control Information, DCI, with Cyclic Redundancy Check, CRC, scrambled by Cell-Radio Network Temporary Identifier, C-RNTI, where the absolute TA command is based on the CFRA preamble; and operate according to the absolute TA command. According to one or more embodiments, the absolute TA command is specific to one of a first Transmission Reception Point, TRP 17, and a second TRP 17, the first and second TRPs 17 being in communication with the wireless device 22.

FIG. 18 is a flowchart of another example process in a wireless device 22 according to some embodiments of the present disclosure. One or more blocks described herein may be performed by one or more elements of wireless device 22 such as by one or more of processing circuitry 84 (including the TA unit 34), processor 86, radio interface 82 and/or communication interface 60. Wireless device 22 is configured to receive (Block S146), from the first TRP 17, an enhanced Physical Downlink Control Channel, PDCCH, order, where the enhanced PDCCH order initiates a random access procedure and indicates that the random access procedure is for timing advance, TA, acquisition only, as described herein. Wireless device 22 is configured to cause (Block S148) transmission of a random access preamble in a physical random access channel, PRACH, according to the enhanced PDCCH order, as described herein. Wireless device 22 is configured to monitor (Block S150) a physical downlink shared channel, PDSCH, for information of a TA associated to the PRACH transmission, as described herein. Wireless device 22 is configured to, in response to receiving the TA carried in the PDSCH (Block S152): exit the random access procedure, and apply the TA to uplink transmissions associated to the TA.

According to one or more embodiments, the enhanced PDCCH order indicates a contention free random access preamble.

According to one or more embodiments, the exit of the random access procedure comprises considering that the random access procedure is successfully completed.

According to one or more embodiments, the enhanced PDCCH order comprises a field that is configured to indicate whether the PDCCH order is for TA acquisition only.

According to one or more embodiments, the enhanced PDCCH order comprises a field that indicates a timing advanced group identifier, TAG ID.

According to one or more embodiments, the TA is provided by a medium access control, MAC, control element, CE, carried in the PDSCH.

According to one or more embodiments, the monitoring of the PDSCH for information of the TA comprises monitoring for downlink control information, DCI, with its cyclic redundancy check, CRC, scrambled by a radio network temporary identifier, RNTI, assigned to the wireless device 22, where the PDSCH is scheduled by the DCI.

According to one or more embodiments, the RNTI is C-RNTI.

According to one or more embodiments, the enhanced PDCCH order further comprises information of a downlink reference signal, DL RS, associated to the PRACH transmission.

According to one or more embodiments, the DL RS is received from one of the first TRP 17 or a second TRP 17.

According to one or more embodiments, if the DL RS is received from the first TRP 17, the transmission of a random access preamble is towards the first TRP 17 and the received TA is for uplink transmissions towards the first TRP 17.

According to one or more embodiments, if the RS is received from the second TRP 17, the transmission of a random access preamble is towards the second TRP 17 and the received TA is for uplink transmissions towards the second TRP 17.

According to one or more embodiments, the processing circuitry 84 is further configured to, in response to the transmission of the random access preamble, start a timer during which to monitor the PDSCH for information of the TA; and if the TA is not receive before expiration of the timer, causing retransmission of the random access preamble with a different transmit power from a previous transmit power for the random access preamble.

According to one or more embodiments, the PDCCH order indicates a number of PRACH retransmissions allowed for acquiring the TA.

Having described the general process flow of arrangements of the disclosure and having provided examples of hardware and software arrangements for implementing the processes and functions of the disclosure, the sections below provide details and examples of arrangements for PDCCH order enhancement.

Some embodiments provide PDCCH order enhancement. One or more network node 16 functions described below may be performed by one or more of processing circuitry 68, processor 70, order unit 32, etc. One or more wireless device 22 functions described below may be performed by one or more of processing circuitry 84, processor 86, TA unit 34, etc.

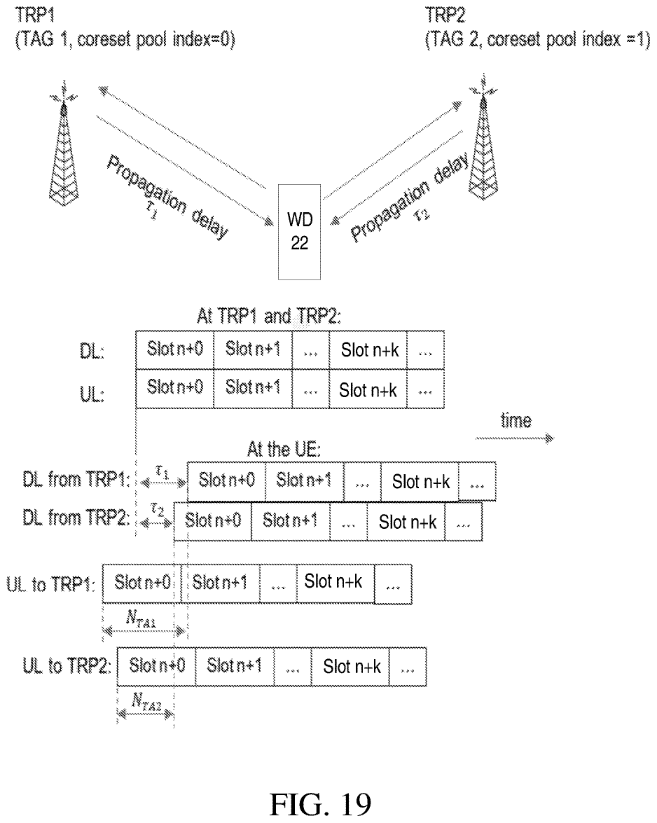

FIG. 19 is a diagram of an example of UL time alignment to two TRPs 17 with two timing advances, N_{TA1} and N_{TA2}. N_{TA1} and N_{TA2} are associated to two TAGs, a first TAG and a second TAG, respectively. Each of the two TAGs is associated with a respective time alignment timer.

In FIG. 19, it is assumed that the DL and UL slot/symbol timings are aligned at the two TRPs, i.e., N_{TA,offset}=0 for both TRPs. Due to different propagation delays from the two TRPs 17 to a wireless device 22, the received DL slot/symbol timings from the two TRPs 17 at the wireless device 22 are shifted in time. To achieve UL time alignment at each TRP 17, the wireless device 22 needs to apply two different timing advances to UL transmissions towards the two TRPs 17.

In FIG. 19, each of the two timing advances is with respect to the received DL timing from the respective TRP. Alternatively, both of the two timing advances may be with respect to a common DL timing at the wireless device 22, e.g., either based on a received DL slot/symbol timing from TRP1 or TRP2.

Note that the “TRP”, i.e., TRP 17 may be considered as, for example, as a network node 16, a base station, an antenna apparatus, an antenna panel, a serving cell, a cell, a Component Carrier (CC), a carrier, and so on. The term “TRP”, “TAG”, and “CORESET pool index” are associated to each other and in the following, they may be interchangeably used in some embodiments.

### GENERAL EMBODIMENT

In a general embodiment, when sending a PDCCH order to the wireless device 22 from the network node 16, information regarding whether the wireless device 22 should follow
Procedure 1: wait for or monitor a corresponding RAR; or.
Procedure 2: monitor PDSCH carrying a MAC CE containing an absolute TA command
   is included in as a field in PDCCH order.

In one embodiment, a PDCCH order for time alignment purpose (i.e., procedure 2 in the above list) may be explicitly indicated to a wireless device 22. The indication can be a new TAG ID field or another new field contained in the PDCCH order. Such a PDCCH order will be referred to as a new or an enhanced PDCCH order.

In one embodiment, a new field in the PDCCH order explicitly indicates whether the wireless device 22 should follow procedure 1 or 2 via a single binary bit. A first value in the new field of the PDCCH order means that the wireless device 22 should follow procedure 1, and a second value in the new field of the PDCCH order means that the wireless device 22 should follow procedure 2.

In another embodiment, a new field in the PDCCH order may indicate if a TAG ID field is present in the PDCCH order or not. A first value in the new field of the PDCCH order means that the TAG ID field is not present in the PDCCH order and that the wireless device 22 should follow procedure 1. A second value in the new field of the PDCCH order means that the TAG ID field is present in the PDCCH order and that the wireless device 22 should follow procedure 2.

An example of the bit fields in the enhanced PDCCH order are as follows:
Random Access Preamble index
UL/SUL indicator
SS/PBCH index
PRACH Mask index
TAG ID (new), or
TA indicator (new)
PRACH transmit power control (new)
Reserved bits

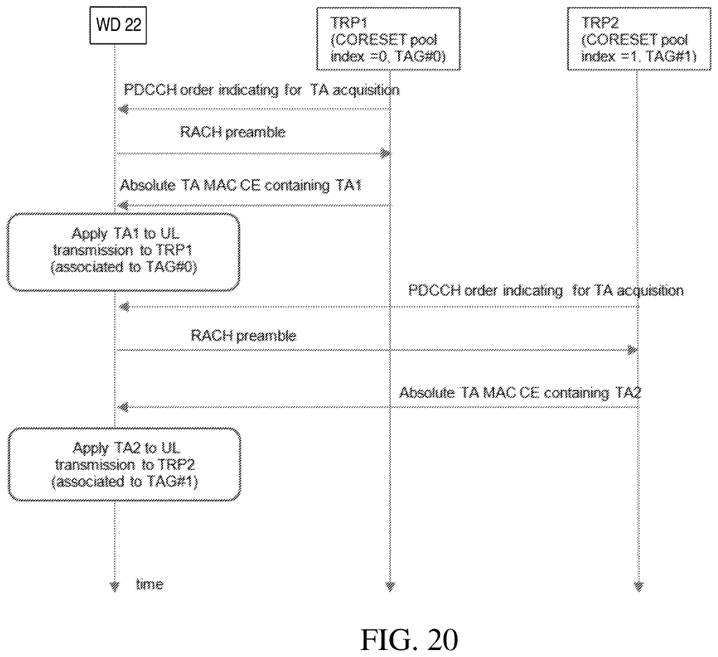

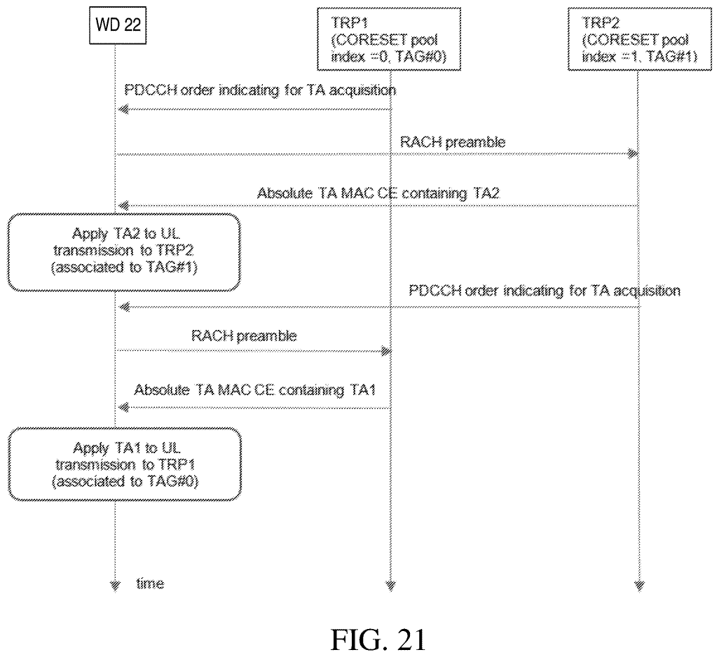

An example is shown in FIG. 20, where each TRP 17 sends a PDCCH order indicating that the triggered PRACH will be for TA acquisition. The PDCCH order is not limited to be used for acquiring TA for a same TRP 17 from which the PDCCH order is sent, it can also be used to trigger a PRACH toward a different TRP as shown in FIG. 21 (e.g., TRP 17 may be from the same cell or different cell or candidate target cell) for acquiring TA for that TRP, and the corresponding absolute TA MAC CE can be received from any TRP 17.

The method in a wireless device 22 for transmitting new type of or enhanced PDDCH-order based RACH

According to one embodiment, a wireless device 22 connected to a network node 16 served with one or more radio nodes (e.g., with two radio nodes TRP1 and TRP2, i.e., TRPs 17), and
receiving an additional higher layer RACH configuration for a new or enhanced type of contention free random access (CFRA) from any of the TRPs 17. Where the additional configuration (compared to the legacy configuration of CFRA) for new PDCCH order contains indication of whether retransmission is allowed or not for CFRA, periodicity of retransmissions if they are allowed, and the maximum number of retransmissions allowed.

Receiving a new type of PDCCH order at the wireless device 22,
Where the new PDCCH order is distinguishable or differentiated to legacy or prior art PDCCH order through a new TAG ID field, or another new field contained in the PDCCH order and also the number of total preamble (re) transmissions allowed.
Start a counter (e.g., nTransmissions) for number of PRACH preamble transmissions.

Transmitting a PRACH preamble as per the indication of new or enhanced PDCCH order received and performing one or more of following actions.
Increment the number of PRACH transmissions by one (e.g., incrementing the counter nTransmissions by 1).
Starting a timer (timer1) with window or length of the timer as configured in the higher layer message or as a fixed value.
Not expecting to receive a RACH response and thus does not monitoring DCI 1-0 with CRC scrambled by RA-RNTI in a type1 CSS set as it would do in the legacy PRACH procedure.

Monitoring the TA command in a time window (W).
Instead, the wireless device 22 monitors DCI with CRC scrambled by its own C-RNTI for a PDSCH carrying a corresponding absolute TA command MAC CE. The monitoring can be performed in any search space set, within a time window after the transmission of the PRACH preamble.
In one example, W, may be same as the one in legacy PRACH procedure. In another example, W may be a different time window defined/configured for a new or enhanced a PDCCH order.
When a MAC CE containing an absolute TA command (TAC) is detected in the time window, the wireless device 22 applies the TA in the TA command to UL transmissions associated to the TAG contained in the PDCCH order or a TAG indicated in the TA command of the MAC CE and start or restart the time alignment timer associated to the TAG. Further resetting the timer1 and deleting the nTransmissions counter. The wireless device 22 then considers the RACH procedure triggered by the PDCCH order is completed.

Retransmitting the PRACH preamble transmission by adjusting the PRACH transmit power (e.g., as indicated in PDCCH order or as indicated in higher layer message) for the retransmission, if any of the following conditions are satisfied.
If the wireless device 22 did not receive a MAC CE containing an absolute TAC within the timer1 expiry (e.g., upon the timer expiry, retransmit the PRACH in the next RACH occasion, and according to the last received PDCCH order by adjusting the PRACH transmit power if the number of retransmissions are less than maximum number of RACH transmissions configured).

If the nTransmissions is equal to a max number of PRACH transmissions configured, release the PDDCH order. Where releasing the PDCCH order means, not transmitting PRACH any further as per the PDCCH order received. Wireless device 22 may wait for next PDCCH order.

In one embodiment, the max number of PRACH transmissions is limited to 1 when the PDCCH order triggered for the purpose of receiving a MAC CE containing an absolute TAC.

In one embodiment, the PDCCH order contains a field that controls the transmit power of the PRACH transmission. The field may indicate whether the PDCCH order is for the first PRACH transmission and wireless device 22 applies the initial PRACH transmit power, or it's a subsequent transmission, in which case the wireless device 22 transmits the PRACH with a transmit power that is larger than the previous transmission. In this case, the field in the PDCCH order may also indicate that the transmit power of the PRACH preamble should correspond to the PRACH transmit power for the kth PRACH re-transmission in the legacy RACH procedure, where k is an integer.

In one embodiment, the field that controls the transmit power of the PRACH transmission can be encoded such that if the field has changed, the wireless device 22 would reset the transmit power, and if the field is the same, the wireless device 22 would ramp its transmit power.

In one embodiment, a dedicated search space pdcchOrderSearchSpace is configured to be associated with PDCCH order indication when more than 1 TA is configured. Wireless device 22 detects the DCI 1_0 carrying PDCCH order only in the PDCCH occasions where the pdcchOrderSeachSpace is configured. A monitoring priority can be configured or pre-defined if this search space collides with other search spaces. One example is the PDCCH order is of the higher priority than USS except the common search spaces: search space configured by pdcch-ConfigSIB1 in MIB, or searchSpaceSIB1, searchSpaceZero, searchSpaceOtherSystemInformation, or pagingSearchSpace in PDCCH-ConfigCommon. In another example the PDCCH order is configured/defined with lowest priority.

### The Method in a Network Node 16 for Configuration of New Type of PDDCH-Order Based RACH

According to a second embodiment, a network node 16 with two radio nodes TRP1 and TRP2,
configures the wireless device 22 served by one of the TRPs 17 with enhanced or new type of contention free RACH where the additional configuration (compared to the legacy configuration of CFRA) for new PDDCH order contain, indication of whether retransmission is allowed or not for CFRA, periodicity of retransmissions if they are allowed, and the maximum number of retransmissions allowed.
Transmitting, via a first TRP 17 and to the wireless device 22, an enhanced PDDCH order with bit fields as indicated in the wireless device 22 embodiment (e.g., a bit field indicating that the PDCCH order is for the purpose of monitoring PDSCH carrying a MAC CE containing an absolute TA command, and/or a TAG ID) to trigger a PRACH transmission toward a second TRP 17. The first TRP 17 and second TRP 17 can be the same or different TRP 17.
Receiving, via the second TRP 17 and from the wireless device 22, the contention free random-access preamble as a response to enhanced PDCCH order.
If the RACH preamble is received successfully, estimating the TA for the received RACH preamble and transmitting, via either the first or the second TRP, to the wireless device 22 an absolute TA command within MAC CE scheduled by a DCI with CRC scrambled by C-RNTI rather than RA-RNTI. The MAC CE may contain a TAG ID associated to the second TRP 17.
optionally, if the RACH preamble if not received successfully, waiting for the retransmission of the PDCCH-order based RACH, if the retransmission(s) are configured.
If the RACH reception is not successful after max number of retransmissions are configured, not waiting for further RACH reception, and completing the PDCCH-order based RACH.

Therefore, one or more embodiments relate to:
Indicating in a PDCCH order whether the PDCCH order is for triggering a PRACH transmission at least for TA acquisition purpose, i.e., an enhanced PDCCH order
If such a PDCCH order is received by a wireless device 22, instead of monitoring a RACH response message (RAR) scheduled by a DCI with CRC scrambled by a RA-RNTI (an ID identifying the associated PRACH preamble and a slot) in a special search space (i.e., Type 1 CSS) as in legacy procedure, the wireless device 22 monitors in any search space set for a PDSCH carrying an absolute timing advance command in a MAC CE addressed to the wireless device after a PRACH transmission according to the PDCCH order, the PDSCH is scheduled by a DCI with CRC scrambled by the wireless device 22's C-RNTI.
If the wireless device 22 has not received the absolute timing advance MAC CE before a predetermined time, the PRACH may be retransmitted if such a retransmission is indicated in the PDCCH order or configured.

Hence, a wireless device 22 can differentiate between PDCCH order for TA acquisition and PDCCH order for other purposes. Wireless device 22 does not need to monitor the RACH response after a PRACH transmission for acquiring a TA associated to a TAG. This is more flexible and allows a time advance command with initial TA to be sent to a wireless device 22 from a same TRP 17 for which a PRACH is sent to, which eliminates the need for message exchange between the two TRP 17, which can be slow.

### EXAMPLES

Example A1. A network node 16 configured to communicate with a wireless device 22, WD 22, the network node 16 configured to, and/or comprising a radio interface 62 and/or comprising processing circuitry 68 configured to:
cause transmission of a Physical Downlink Control Channel, PDCCH, order to the wireless device 22, the PDCCH order including a field indicating whether the wireless device 22 is to one of:
   monitor for a Random Access Response, RAR; and
   monitor a Physical Downlink Shared Channel, PDSCH, carrying an absolute timing advance, TA, command; and
the field being a non-legacy field.

Example A2. The network node 16 of Example A1, wherein the field is a Timing Advance Group, TAG, Identifier, ID, field.

Example A3. The network node 16 of Example A1, wherein the indication indicates to monitor the PDSCH carrying an absolute TA command, the indication is configured to trigger a Physical Random Access Channel, PRACH, transmission, the PRACH transmission including the transmission of a Contention Free Random Access, CFRA, preamble.

Example A4. The network node 16 of Example A3, wherein the processing circuitry 68 is further configured to:
estimate TA based on the CFRA preamble;
cause transmission of an absolute TA command within a Medium Access Control, MAC, Control element, CE, scheduled by a Downlink Control Information, DCI, with Cyclic Redundancy Check, CRC, scrambled by Cell-Radio Network Temporary Identifier, C-RNTI.

Example A5. The network node 16 of Example A4, wherein the absolute TA command is specific to one of a first Transmission Reception Point, TRP, and a second TRP point, the first and second TRPs being in communication with the wireless device 22.

Example B1. A method implemented in a network node 16, the method comprising:
causing transmission of a Physical Downlink Control Channel, PDCCH, order to the wireless device 22, the PDCCH order including a field indicating whether the wireless device 22 is to one of:
   monitor for a Random Access Response, RAR;
   monitor a Physical Downlink Shared Channel, PDSCH, carrying an absolute timing advance, TA, command; and
the field being a non-legacy field.

Example B2. The method of Example B1, wherein the field is a Timing Advance Group, TAG, Identifier, ID, field.

Example B3. The method of Example B1, wherein the indication indicates to monitor the PDSCH carrying an absolute TA command, the indication is configured to trigger a Physical Random Access Channel, PRACH, transmission, the PRACH transmission including the transmission of a Contention Free Random Access, CFRA, preamble.

Example B4. The method of Example B3, further comprising:
estimating TA based on the CFRA preamble;
causing transmission of an absolute TA command within a Medium Access Control, MAC, Control element, CE, scheduled by a Downlink Control Information, DCI, with Cyclic Redundancy Check, CRC, scrambled by Cell-Radio Network Temporary Identifier, C-RNTI.

Example B5. The method of Example B4, wherein the absolute TA command is specific to one of a first Transmission Reception Point, TRP, and a second TRP point, the first and second TRPs being in communication with the wireless device 22.

Example C1. A wireless device 22 (WD 22) configured to communicate with a network node 16, the WD 22 configured to, and/or comprising a radio interface 82 and/or processing circuitry 84 configured to:
receive a Physical Downlink Control Channel, PDCCH, order, the PDCCH order including a field being a non-legacy field and indicating whether the wireless device 22 is to one of:
   monitor for a Random Access Response, RAR; and
   monitor a Physical Downlink Shared Channel, PDSCH, carrying an absolute timing advance, TA, command; and
in response to the PDCCH order, one of:
   monitor for the RAR; and
   monitor the PDSCH carrying an absolute TA command.

Example C2. The WD 22 of Example C1, wherein the field is a Timing Advance Group, TAG, Identifier, ID, field.

Example C3. The WD 22 of Example C1, wherein the indication indicates to monitor the PDSCH carrying an absolute TA command, the indication is configured to trigger a Physical Random Access Channel, PRACH, transmission, the PRACH transmission including the transmission of a Contention Free Random Access, CFRA, preamble.

Example C4. The WD 22 of Example C3, wherein the processing circuitry 84 is further configured to:
receive an absolute TA command within a Medium Access Control, MAC, Control element, CE, scheduled by a Downlink Control Information, DCI, with Cyclic Redundancy Check, CRC, scrambled by Cell-Radio Network Temporary Identifier, C-RNTI, the absolute TA command being based on the CFRA preamble; and
operate according to the absolute TA command.

Example C5. The WD 22 of Example C4, wherein the absolute TA command is specific to one of a first Transmission Reception Point, TRP, and a second TRP point, the first and second TRPs being in communication with the wireless device 22.

Example D1. A method implemented in a wireless device 22 (WD 22), the method comprising:
receiving a Physical Downlink Control Channel, PDCCH, order, the PDCCH order including a field being a non-legacy field and indicating whether the wireless device 22 is to one of:
   monitor for a Random Access Response, RAR; and
   monitor a Physical Downlink Shared Channel, PDSCH, carrying an absolute timing advance, TA, command; and
in response to the PDCCH order, one of:
   monitoring for the RAR; and
   monitoring the PDSCH carrying an absolute TA command.

Example D2. The method of Example D1, wherein the field is a Timing Advance Group, TAG, Identifier, ID, field.

Example D3. The method of Example D1, wherein the indication indicates to monitor the PDSCH carrying an absolute TA command, the indication is configured to trigger a Physical Random Access Channel, PRACH, transmission, the PRACH transmission including the transmission of a Contention Free Random Access, CFRA, preamble.

Example D4. The method of Example D3, further comprising:
receiving an absolute TA command within a Medium Access Control, MAC, Control element, CE, scheduled by a Downlink Control Information, DCI, with Cyclic Redundancy Check, CRC, scrambled by Cell-Radio Network Temporary Identifier, C-RNTI, the absolute TA command being based on the CFRA preamble; and
operating according to the absolute TA command.

Example D5. The method of Example D4, wherein the absolute TA command is specific to one of a first Transmission Reception Point, TRP, and a second TRP point, the first and second TRPs being in communication with the wireless device 22.

### STANDARDIZING THE PROPOSED SOLUTIONS

The description below provides non-limiting examples of how certain aspects of the proposed solutions could be implemented within the framework of a specific communication standard. In particular, the description below provides non-limiting examples of how the proposed solutions could be implemented within the framework of a 3GPP TSG RAN standard. The changes described below are merely intended to illustrate how certain aspects of the proposed solutions could be implemented in a particular standard. However, the proposed solutions could also be implemented in other suitable manners, both in the 3GPP Specification and in other specifications or standards.

### Two TAs for Multi-DCI

### Introduction

During RAN #94e, a new WID for Rel-18 MIMO evolution for DL and UL was agreed. Part of objective 7 is relevant for this AI:

```
7. Study, and if justified, specify the following
  - Two TAs for UL multi-DCI for multi-TRP operation
  - Power control for UL single DCI for multi-TRP operation where unified TCI
    framework extension in objective 2 is assumed.
    For the case of simultaneous UL transmission from multiple panels, the operation
    will only be limited to the objective 6 scenarios.
```

For completeness, the full objective is included. The part that is not applicable for this AI is written in italics.

In this contribution, we discuss how to support two TAs for multi-DCI based multi-TRP operation.

### DISCUSSION

In this contribution, it is discussed how to specify two TAs for multi-DCI multi-TRP operation.

During RA1 #109-e, the following was agreed:

Agreement

```
Two TA enhancement for uplink multi-DCI based multi-TRP operation are
applicable to at least:
  • TDM based multi-DCI uplink transmission
  • simultaneous multi-DCI uplink transmission (if simultaneous uplink multi-
    DCI uplink transmission is supported in Agenda 9.1.4.1)
Note: Whether two TA enhancement is applicable to other schemes is a separate
discussion, which is not in the scope of AI 9.1.1.2.
```

The agreement states that the enhancement should be applicable at least to multi-DCI uplink transmission. It is noted that enhancements to TA handling is also part of the WI Further NR Mobility Enhancements.

So far, only one scheme for TA handling is specified in NR. The same TA handling scheme is used for all scenarios. This is clearly advantageous, and it should be a target to maintain one solution for TA handling also for the solutions specified in Rel-18.

Since the aim is to design one scheme for TA handling, it should avoid basing the solution on properties that are only available for multi-DCI multi-TRP. Such design choices would effectively rule out reusing the solution for other cases. Hence, it is proposed:

Proposal 1 do not Design the Two-TA Handling on Properties that are Only Available for Multi-DCI Multi-TRP Transmission.

By designing the solution based on properties of the individual signals, rather than the specific transmission scheme, the range of use cases that can be support increases drastically. Not only is it reasonable to assume that we can support the enhanced mobility schemes, but it also becomes possible to support single-DCI based multi-TRP, e.g., STxMP.

In the past few meetings, RAN1 made the following agreements:

```
Agreement (RAN1#110)
For multi-DCI based multi-TRP operation with two TAs, support configuring two
TAGs belonging to a serving cell.
Agreement (RAN1#110)
For multi-DCI multi-TRP operation with two TAs, up to two n-
TimingAdvanceOffset value per serving cell is supported
Agreement (RAN1#110bis-e)
For multi-DCI multi-TRP operation with two TAs in a CC, two DL reference timings
are supported where each DL reference timing is associated with one TAG
  • baseline assumption is that the Rx timing difference between the two DL
    reference timings is no larger than CP length
  • as an optional UE capability, Rx timing difference between the two DL
    reference timings can be assumed to be larger than CP length
      ○ FFS: the maximum Rx timing difference (could be up to RAN4)
      ○ Other than UE capability details and relevant configuration, no
          additional RAN1 specification enhancement specific for this case is
          expected
```

The support of two TAs is thus handled via two TAGs, each associated with a DL reference timing. The UE applies the TA associated with each TAG to the corresponding reference timing. The NW can use the legacy Timing Advance Command MAC CE defined in section 6.1.3.4 of 3GPP TS 38.321 v.17.0.0 to adjust the TA for each TAG.

In addition to the Timing Advance Command MAC CE, which performs (small) relative adjustments of the transmission timing, it is also necessary to perform an initial, larger, adjustment of the TA. In RAN1 #110bis-e, RAN1 made the following agreement:

Agreement

```
For multi-DCI based Multi-TRP operation with two TA enhancement, support
enhancements related to indicating TAG ID via absolute TA command:
  • FFS: whether the indication is implicit or explicit
  • Detailed indication schemes are FFS
  • This does not preclude indication of two TAG IDs (if supported)
  • Note: This applies at least to MSGB in case of C-RNTI
```

The absolute TA command is described in section 6.1.3.4a in 3GPP TS 38.321 v.17.0.0, and is shown in FIG. 6.

The preferred way to enhance the absolute TA command is to simply introduce the TAG ID, using two of the reserved bits:

### Proposal 2 Introduce One TAG ID in the Absolute Timing Advance MAC CE.

Referring to the subbullets in the agreement, this would be an explicit indication.

There is no motivation to include more than one TAG ID in the MAC CE: since the absolute TA command is used quite rarely, it is very unlikely there will be a situation where both TAGs need to be updated at the same time. In the unlikely event that this happens, two MAC CEs could be sent in the same MAC PDU.

In the note, it is stated that the absolute MAC CE can be used at least of MSGB. There may not need to be a limit the use of the absolute MAC CE: it can be used at any time:

### Observation 1 the Absolute TAC MAC CE can be Used at any Time.

The TA remains valid until the TA timer associated with the TAG expires. When the corresponding TA timer expires, the UE is not allowed to transmit PUCCH, PUSCH or SRS for the serving cell configured with the corresponding TAG: the UE is only allowed to transmit PRACH on the serving cell.

This concept can easily be extended to the case where the TAG is included in a TCI state: transmission of PUCCH, PUSCH and SRS is allowed only if the timer associated with the TAG in the corresponding TCI state has not expired:

Proposal 3 Transmission of PUCCH, PUSCH and SRS is Only Allowed if the Timer Associated with the TAG in the Corresponding TCI State has not Expired.
Associating Different TAs with Different UL Transmissions

The following was agreed in RAN1 #110bis-e:

Agreement

```
For associating TAGs to target UL channels/signals for multi-DCI based multi-TRP
operation, the four options agreed in RAN1#110bis-e are refined as below (down-
selection of one or a combination of the options to be performed in RAN1#111):
  ○ Option 1: Associate TAG to TCI-state/spatial relation
    · Configure TAG ID as part of UL/joint TCI state or spatial relation
    · for UL transmission, the TAG ID associated with the UL/joint TCI
      state or spatial relation is utilized
  ○ Option 2: Associate TAG to CORESETPoolIndex
    · for dynamically scheduled/activated PUSCH, TAG associated with
    · the CORESET pool index of the CORESET carrying the
      scheduling/activating PDCCH is utilized for UL transmission
    · for Type 1 CG, P/SP-SRS, and P/SP-PUCCH, coresetPoolIndex is
      RRC-configured.
    · FFS: Other signals/channels: AP-SRS, and dynamic HARQ-ACK
  ○ Option 3: Associate TAG to SSB group (if such an association is agreed in
      agenda 9.1.1.2). For a UL transmission, UE adopts the TAG associated with
      the SSB group such that
    · if the PL RS is an SSB, then the UE adopts the TAG associated with
      the SSB group which the PL RS of the UL transmission belongs to
      if the PL RS is a CSI-RS, then the UE adopts the TAG associated with
      the SSB group which the QCL source SSB of the PL RS belongs to
  ○ Option 4: TAG association performed as follows:
    · for dynamically scheduled/activated channels/signals, TAG associated
      with the CORESET pool index of the CORESET carrying the
      scheduling PDCCH is utilized for UL transmission
    · for P/SP UL channels / signals (not scheduled or activated by DCI),
      TAG ID is RRC-configured.
```

The four options are looked at in more detail.

It is noted that for the Rel-17 TCI framework, every UL transmission is associated with a joint UL/DL or UL TCI state, and that transmissions to different TRPs must be associated with different joint UL/DL or UL TCI states:

Observation 2 UL Transmissions to Different TRPs Will be Associated with Different Joint UL/DL or UL TCI States.

Moreover, the TCI state will contain a DL reference signal, either the RS that defines the spatial UL TX filter, or the PL RS. This DL RS could be used to define the timing reference for the corresponding UL transmission. One DL RS is transmitted from one TRP, so the timing defined by a DL RS is the timing of the corresponding TRP.

Observation 3 the DL Reference Signal in the TCI State can be Used as Timing Reference for any UL Transmission Associated with that TCI State.

The same principle can be used for the Rel-15 TCI framework: the TAG ID would be included in the spatial relation. Although spatial relations are not applicable to FR1, there is nothing that prevents that the NW (network) signals this to the UE also for FR1:

Observation 4 in Principle, there is Nothing that Prevents the NW from Providing the UE with a Spatial Relation Also in FR1.

A solution where the TAG ID is included in the UL TCI state/spatial relation would make it possible to use the solution also for single-DCI mTRP, and potentially also for a mobility solution.

Also, the TCI state contains information that supports the UEs reception and transmission: it contains RSs that facilitate DL reception (to derive DL timing), and UL power control. Adding a quantity that facilitates adjustment of the transmission timing would be similar type of information: related to the physical properties of the reception or transmission.

In contrast, physical properties of UL transmissions are not associated with CORESETPoolIndex: CORESETPoolIndex is only related to DL transmissions. Physical properties of UL transmissions are derived from SRS or PUCCH resources, and neither of these has any relation to the CORESETPoolIndex:

Observation 5 Physical Properties of UL Transmissions are not Associated with Coresetpoolindex.

Furthermore, there is no unambiguous association between a DL RS and a CORESETPoolIndex. Every CORESET has a QCL source, which is a DL RS, but different CORESETs associated with the same CORESETPoolIndex can in principle have different QCL sources:

Observation 6 there is No Unambiguous Association Between a DL RS and a CORESETPoolIndex.

Option 3 proposes to associate the TAG with a DL RS group. The association is performed via the PL RS of an UL transmission. In many cases, this approach could work. Note however that one or more embodiments may support cases where the PL RS and the RS providing the spatial Tx filter are different, and in this case, the TAG should be associated with the RS providing the spatial Tx filter (which is in the TCI state), and not the PL RS.

Option 4 has the same disadvantages as option 2: association between a TAG ID and a CORESETPoolIndex is not logical.

Based on the above analysis, it is concluded that the best (or one) solution is to include a TAG in each joint UL/DL TCI state, UL TCI state or spatial relation. Any UL transmission that relies on a TCI state or a spatial relation would apply the TA associated with the TAG included in the TCI state:

### Proposal 4 Include a TAG in Each Joint TCI State, UL TCI State or Spatial Relation.

As noted in Observation 3, there is also a natural choice of the timing reference:

Proposal 5 the Timing Reference for any UL Transmission is the Reference Signal Providing the UL TX Spatial Filter. If the RS Providing the UL Spatial TX Spatial Filter is an SRS, the PL RS for the UL TCI State Provides the Timing Reference.

In other words, the UE would apply the TA associated with the TAG in a TCI state to the receive timing of the DL RS in the same TCI state. The resulting Tx timing is used for the PUCCH, PUSCH and SRS for which the corresponding TCI state is indicated.

Hence, Proposal 5 provides a solution not only how to associate a TAG and a TRP, but also on how to associate a TAG and a reference timing.

One potential issue is that in Rel-17, UL transmissions may not be associated with TCI states in FR1. However, there is nothing that prevents that UL transmissions are associated with TCI states also in FR1: for example, power control parameters can still be associated with TCI states in FR1 for Rel-17. In fact, as shown in R1-2211051, it becomes necessary to associate UL transmissions with TCI states as soon as we want to support UL power control for mTRP using the unified TCI framework. Hence, we observe

Observation 7 UL Transmissions can be Associated with TCI States Also in FR1.

We note that the Rel-17 TCI states are also a part of the solutions for inter-cell beam management in Rel-17, and including the TA in a Rel-17 TCI state could make it possible to reuse the Ta enhancement also for the mobility enhancements:

Observation 8 A Solution that Integrates the TA with the Rel-17 TCI Framework could Potentially be Reused Also for Mobility Enhancements.

In contrast, a solution based on CORESET pool index could not be reused in the mobility work, since mobility must work also without NC-JT.

### Enhancements to the RACH Procedure

With the agreement of using two TAGs in a serving cell configuration, gradual adjustments of the TA can be performed using the legacy Timing Advance Command MAC CE. The NW can use the reception of any UL transmission to determine that the TA needs to be adjusted. With Proposal 2, it is also possible to set an absolute TA, i.e., an initial TA, for any TAG. However, based on current functionality, it may be challenging for the NW to determine what would be a suitable value for the initial TA. Typically, the NW uses the reception of a PRACH to determine a suitable value for the initial TA, but the legacy RACH procedure is somewhat inadequate to handle different TAs for different TRPs. Therefore, RAN1 made the following agreement in RAN1 #110:

Agreement

```
For multi-DCI based multi-TRP operation with two TAs, study the impact of two
TAs for the following:
  - RACH triggered by PDCCH order in intra-cell MTRP case
  - RACH triggered by PDCCH order in inter-cell MTRP case
        ○ Which might require RACH enhancement as well
  - UE triggered RACH by CBRA or CFRA in RRC connected mode
Further details of enhancements needed (if any)
```

The foreseen scenario is that the TA for one of the TRPs is available, and communication is possible. The NW would like to
1. obtain the TA corresponding to the other TRP
2. send a TAC for the corresponding TAG to the UE

Note that these two steps are independent. In legacy, this is more of a theoretical possibility, since communication is impossible before the UE has a valid TA: the NW must send the obtained TA to the UE as soon as possible.

The second step should be achieved with the enhanced absolute TAC in Proposal 2:

### Observation 9 the Enhanced Absolute TAC can be Used to Send the Absolute TA to the UE for the Second TRP.

What remains is then to make it possible for the NW to measure the TA corresponding to the other TRP. This measurement is performed on a PRACH preamble. In some cases, multiple TRPs can receive the same PRACH transmission, but this is not possible in all cases. Hence, there is a need to enhance the RACH procedure to facilitate PRACH transmission towards the other TRP. It is probably not a good idea to reuse the full RACH procedure for this scenario, since the subsequent steps of the RACH procedure are very much tailored to the single-TRP case:

### Observation 10 the Legacy RACH Procedure is Tailored to the Single-TRP Deployment.

For the RACH enhancements, it is also important to take the work in the mobility WI into account. In RAN1 #110bis-e, the following was agreed:

Agreement

```
  - Support TA acquisition of candidate cell(s) before cell switch command is
    received in L1/L2 based mobility.
    ✓ FFS: whether this can be applied to candidate cell when it is deactivated
          SCell (if defined in RAN2)
```

This points to that 3GPP will specify a way to trigger a PRACH transmission to a candidate cell, and it would be beneficial if the RACH enhancements are applicable both to mTRP and to mobility:

Observation 11 it would be Beneficial if the RACH Enhancements are Applicable Both to mTRP and Mobility.

The traditional NW-initiated approach to determine the TA for a UE is via a PDCCH order. The legacy PDCCH order triggers a RACH procedure towards the serving cell, and the subsequent RAR includes a new TA for the UE. The PDCCH order relies on the RACH configurations, either common or dedicated. In addition, it is possible to provide a limited set of configuration parameters in the PDCCH order itself.

In RAN1 #110bis-e, the following agreement was made:

Agreement

```
For multi-DCI based Multi-TRP operation with two TA enhancement, support one of
the following alternatives in RAN1#111:
  • Alt 1: PDCCH order sent by one TRP triggers RACH procedure towards the
      same TRP
      ○ note: with Alt 1, PDCCH order sent by one TRP triggering RACH
          procedure towards another TRP is not allowed
  • Alt 2: PDCCH order sent by one TRP triggers RACH procedure towards either
      the same TRP or a different TRP
      ○ This does not preclude PDCCH order triggering two RACH procedures
          for two TRPs
```

Here we note that only Alt2 would work for the mobility case, since the UE can only receive PDCCH from a serving cell:

Observation 12 Only Alt2 would Work for the Mobility Case Since the UE can Only Receive PDCCH from a Serving Cell.

Since it is important not to specify multiple solutions for the same problem, it is proposed:

### Proposal 6 Support Alt2: A PDCCH Order Sent by One TRP Triggers RACH Procedure Towards Either the Same TRP or a Different TRP.

The next issue to discuss is what the UE monitors after sending the PRACH. Here RAN1 made the following agreement:

Agreement

```
For inter-cell multi-DCI based Multi-TRP operation with two TA enhancement,
support one of the alternatives (down selection to be done in RAN1#111):
  • Alt 1: PDCCH scheduling RAR will always be received from serving cell
      there is no need for additional type 1 CSS configuration per additional PCI
  • Alt 2: In addition to PDCCH scheduling RAR being received from serving
      cell, reception of PDCCH scheduling RAR from a TRP corresponding to an
      additional PCI for a RACH procedure associated to the additional PCI is
      supported → additional type 1 CSS configuration per additional PCI needs to
      be supported
```

Again, coming back to mobility, it is critical to avoid an interruption in the communication with the serving cell. For a UE not capable of multiple active TCI states, monitoring type1 CSS from another cell would lead to an interruption with the serving cell, and this is highly undesirable. Since it may be desired to reuse the same solution for mobility as for mTRP, it is proposed:

Proposal 7 Support Alt1: A PDCCH Scheduling RAR Will Always be Received from serving cell->there is no need for additional type 1 CSS configuration per additional PCI.

Based on Proposal 6 and Proposal 7, the overall procedure would be
1. The NW sends a PDCCH order from the TRP with a valid TA, which triggers a PRACH towards the other TRP
2. The UE receives an absolute TAC from the TRP with a valid TA

It is noted that 1. relies on the following agreement from RAN1 #110bis-e:

Agreement

For multi-DCI based inter-cell Multi-TRP operation with two TA enhancement,
support a mechanism to determine which PRACH configuration (i.e., RACH
configuration corresponding to serving cell PCI or an additional PCI) to be used in the
RACH procedure triggered by PDCCH order
• FFS: Explicit indication or implicit indication through PDCCH order

Although the agreement is related to inter-cell operation, the same functionality can and must be used also for the intra-cell case.

One interesting fact with the above procedure is that no RAR is needed. In a legacy RACH procedure triggered by a PDCCH order, the UE will repeat the transmission until it receives a RAR. RAR has a very particular format, which is designed to work in situations where there is no dedicated configuration for the UE. However, in this case, the only thing the UE needs is the absolute TAC, and that can be sent more efficiently, e.g., using the enhanced absolute TAC MAC CE in Proposal 2.

As mentioned above, in a legacy RACH procedure, the UE would repeat the PRACH transmission until it receives the RAR. This is critical for a RACH procedure initiated by the UE, but it makes less sense for a contention-free RACH procedure triggered by a PDCCH order, and for establishment of a TA to another TRP, it is even problematic: there is no information in the RAR that would make it possible for the UE to identify which TRP/TAG the RAR refers to. It is also noted that a solution relying on multiple TAGs may not work for a mobility solution, and it would be beneficial to have one solution to measure TA both for mobility and mTRP.

To avoid these issues, it is proposed to introduce a new type of PDCCH order. This new type of PDCCH order would only trigger a single PRACH transmission:

Proposal 8 Introduce a New Type of PDCCH Order that Only Triggers the Transmission of a Single Instance of a PRACH Preamble.

As used herein, a PDCCH order may be referred to a type 2 PDCCH order.

The type 2 PDCCH order would also include pointers to the PRACH configuration that facilitates transmission towards another TRP/cell. This is in line with the following agreement from RAN1 #110bis-e:

Agreement

For multi-DCI based inter-cell Multi-TRP operation with two TA enhancement,
support a mechanism to determine which PRACH configuration (i.e., RACH
configuration corresponding to serving cell PCI or an additional PCI) to be used in
the RACH procedure triggered by PDCCH order
• FFS: Explicit indication or implicit indication through PDCCH order

Overall, the RACH configuration is large, and for the purpose, it should provide the PRACH preamble and SSB index explicitly in the PDCCH order, using the legacy fields. This means that a lot of the configuration information is unnecessary. Therefore, it is proposed:

Proposal 9 RAN1 should List What PRACH Configurations Parameters are Needed to Trigger a Type 2 PDCCH Order.

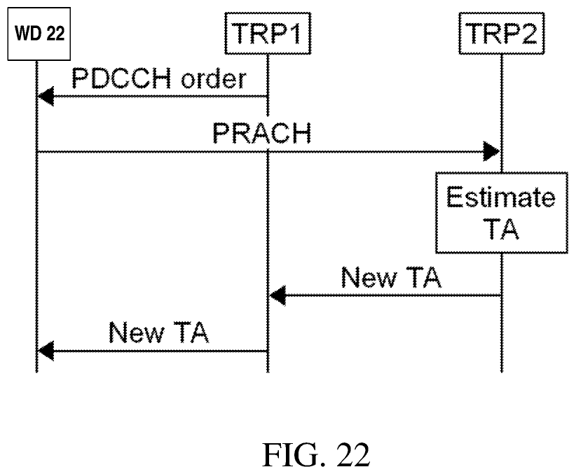

The procedure is illustrated in FIG. 22 that is a signaling diagram of obtaining initial TA using type 2 PDCCH order.

Note that with the procedure outlined in FIG. 22, the UE does not have to monitor for RA-RNTI: it just continues to monitor for C-RNTI.

It is noted that the type 2 PDCCH order described above could also be used for L1/L2 mobility. In this case, TRP2 is a candidate cell for which the NW would like to obtain the TA before the mobility execution. For this case, it is necessary that the RACH procedure is triggered by TRP1 (the serving cell), and that the new TA is estimated in TRP2 (the candidate cell), and sent from TRP1 (the serving cell):

### Observation 13 the Type 2 PDCCH Order can be Used Also for L1/L2 Mobility.

There have also been discussions on UE-triggered RACH by CBRA or CFRA in RRC connected mode. There are a few events that cause the UE to initiate a RACH procedure in connected mode:
During RRC reconfiguration with sync
When the maximum number of SR transmissions have been performed
When the timeAlignmentTimer expires, and the UE has something to transmit in UL
During BFR

The impact would be different for the different cases. Therefore, it is proposed to further clarify which cases would be considered, and which aspects of the RACH procedure to investigate:

### Proposal 10 Further Clarify What Aspects of the UE-Triggered RACH Procedure Should be Studied.

### Handling Overlap Between UL Transmissions

UL transmissions associated with different TAs may overlap: the TA compensates for the difference in propagation delay, and if the UL transmissions are received slot-aligned at two different TRPs with different propagation delays, they cannot be transmitted slot-aligned.

In R1-2210817, RAN1 received a response LS from RAN4 on the maximum uplink timing difference. RAN4 responded

For a UE capable of supporting Receive Time Difference (RTD) > CP,
MRTD/MTTD value for FR1 is 33/34.6 μs and MRTD/MTTD value for FR2 is
8/8.5 μs.
For a UE not capable of supporting RTD>CP, MTTD is within (CP + M1 μs)
for FR1 and MTTD is within (CP + M2 μμs) for FR2. Where M1 and M2 are FFS
in RAN4.

RAN1 has agreed to support RTD>CP, meaning that the specification must cater for that situation. These MTTD values directly translate to an overlap of the same length:

### Observation 14 the Maximum Overlap is 34.6 μs for FR1 and 8.5 μs for FR2.

In RAN1 #110, the following was agreed:

Agreement

```
For multi-DCI based multi-TRP operation with two TAs, study how to handle
overlapping part between two UL transmissions associated with two TAs, where
the study includes:
  ○ whether to introduce scheduling restriction in overlapping part
whether to introduce dropping rules
  ○ whether specification impact is needed, or if the issue can be handled via
implementation
  ○ whether to allow overlapped transmission in case the UE supports STxMP
transmission (if STxMP feature is agreed in NR Rel-18)
```

Furthermore, in RAN1 #110bis-e, the following conclusion was drawn:

Conclusion

```
For multi-DCI based Multi-TRP operation with two TA enhancement, it cannot
always be assumed that both TRPs have knowledge of the overlapping region
between transmissions corresponding to the two TAs.
  • Note: This doesn't prevent the network from applying scheduling
      restrictions even if the TRPs have no knowledge of the overlapping
      region
```

The above conclusion means that since the NW does not know the difference in uplink transmit timing, it cannot apply any dynamic scheduling restrictions. Essentially, the scheduling restriction would have to assume the maximum timing difference-always. Since the MTTD may be (slightly) larger than a symbol, this would mean that the NW would always have to blank two symbols:

Observation 15 a Static Scheduling Restriction would have to Avoid Two Symbols at Every Slot Boundary.

Always using such a drastic scheduling restriction is undesirable. In contrast, a dropping rule would only impact the actual overlap. Based on this, it is proposed

### Proposal 11 if UL Transmissions are Overlapping, the UE Drops a Part of One of the Transmissions.

It is noted that there already exists a rule to handle overlapping UL transmissions in 3GPP 38.213:

Excerpt from 38.213, clause 4.2:

If two adjacent slots overlap due to a TA command, the latter slot is reduced in
duration relative to the former slot. The UE does not change N_{TA} during an actual
transmission time window for a PUSCH or a PUCCH transmission [6, TS 38.214].

In legacy, the reason for the overlap is that the (single) TA changes from one slot to another, which is a rather rare event. Note that the legacy rule may imply that the DMRS is dropped, which would destroy make it impossible to receive the UL transmission in the later slot. Since the overlap will be more common for the mTRP deployment, the legacy principle may not be suitable. Instead, it is proposed that the earlier slot is shortened, to ensure that the UE transmits DMRS in the later slot:

Proposal 12 if UL Transmissions Associated with Different TAs Overlap, the Earlier Slot is Reduced in Duration Relative to the Later Slot.

This would mean that the last part of the first slot is dropped, which will lead to worsened performance at reception. But since the UE cannot transmit both signals at the same time, the UE will not be able to transmit for the full duration of the two slots, and this will lead to a performance loss—there is no way to avoid that. Shortening of the first slot will impact the link adaptation, but the outer-loop link adaptation in the gNB will take care of that. Alternatively, the gNB can adapt its scheduling to avoid the overlap, which is up to NW implementation.

### CONCLUSION

In the previous sections, the following observations were made:
Observation 1 The absolute TAC MAC CE can be used at any time.
Observation 2 UL transmissions to different TRPs will be associated with different joint UL/DL or UL TCI states.
Observation 3 The DL reference signal in the TCI state can be used as timing reference for any UL transmission associated with that TCI state.
Observation 4 In principle, there is nothing that prevents the NW from providing the UE with a spatial relation also in FR1.
Observation 5 Physical properties of UL transmissions are not associated with CORESETPoolIndex.
Observation 6 There is no unambiguous association between a DL RS and a CORESETPoolIndex.
Observation 7 UL transmissions can be associated with TCI states also in FR1.
Observation 8 A solution that integrates the TA with the Rel-17 TCI framework could potentially be reused also for mobility enhancements.
Observation 9 The enhanced absolute TAC can be used to send the absolute TA to the UE for the second TRP.
Observation 10 The legacy RACH procedure is tailored to the single-TRP deployment.
Observation 11 It would be beneficial if the RACH enhancements are applicable both to mTRP and mobility.
Observation 12 Only Alt2 would work for the mobility case since the UE can only receive PDCCH from a serving cell.
Observation 13 The type 2 PDCCH order can be used also for L1/L2 mobility.
Observation 14 The maximum overlap is 34.6 μs for FR1 and 8.5 μs for FR2.
Observation 15 A static scheduling restriction would have to avoid two symbols at every slot boundary.

Based on the discussion in the previous sections we propose the following:
Proposal 1 Do not design the two-TA handling on properties that are only available for multi-DCI multi-TRP transmission.
Proposal 2 Introduce one TAG ID in the absolute Timing Advance MAC CE.
Proposal 3 Transmission of PUCCH, PUSCH and SRS is only allowed if the timer associated with the TAG in the corresponding TCI state has not expired.
Proposal 4 Include a TAG in each joint TCI state, UL TCI state or spatial relation.
Proposal 5 The timing reference for any UL transmission is the reference signal providing the UL TX spatial filter. If the RS providing the UL spatial TX spatial filter is an SRS, the PL RS for the UL TCI state provides the timing reference.
Proposal 6 Support Alt2: a PDCCH order sent by one TRP triggers RACH procedure towards either the same TRP or a different TRP.
Proposal 7 Support Alt1: a PDCCH scheduling RAR will always be received from serving cell->there is no need for additional type 1 CSS configuration per additional PCI.
Proposal 8 Introduce a new type of PDCCH order that only triggers the transmission of a single instance of a PRACH preamble.
Proposal 9 RAN1 should list what PRACH configurations parameters are needed to trigger a type 2 PDCCH order.
Proposal 10 Further clarify what aspects of the UE-triggered RACH procedure should be studied.
Proposal 11 If UL transmissions are overlapping, the UE drops a part of one of the transmissions.
Proposal 12 If UL transmissions associated with different TAs overlap, the earlier slot is reduced in duration relative to the later slot.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| TA | Timing Advance |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device configured to communicate with at least a first transmission and reception point, TRP, comprising:
processing circuitry configured to:
receive, from the first TRP, an enhanced Physical Downlink Control Channel, PDCCH, order, the enhanced PDCCH order initiating a random access procedure and indicating that the random access procedure is for timing advance, TA, acquisition only;
cause transmission of a random access preamble in a physical random access channel, PRACH, according to the enhanced PDCCH order;
monitor a physical downlink shared channel, PDSCH, for information of a TA associated to the PRACH transmission; and
in response to receiving the TA carried in the PDSCH:
exit the random access procedure; and
apply the TA to uplink transmissions associated to the TA.

2. The wireless device of claim 1, wherein the enhanced PDCCH order indicates a contention free random access preamble.

3. The wireless device of claim 1, wherein the exit of the random access procedure comprises considering that the random access procedure is successfully completed.

4. The wireless device of claim 1, wherein the enhanced PDCCH order comprises a field that is configured to indicate whether the PDCCH order is for TA acquisition only.

5. The wireless device of claim 1, wherein the enhanced PDCCH order comprises a field indicates a timing advanced group identifier, TAG ID.

6.-12. (canceled)

13. The wireless device of claim 1, wherein the processing circuitry is further configured to, in response to the transmission of the random access preamble, start a timer during which to monitor the PDSCH for information of the TA; and
if the TA is not received before expiration of the timer, causing retransmission of the random access preamble with a different transmit power from a previous transmit power for the random access preamble.

14.-27. (canceled)

28. A method implemented by a wireless device that is configured to communicate with at least a first transmission and reception point, TRP, the method comprising:
receiving, from the first TRP, an enhanced Physical Downlink Control Channel, PDCCH, order, the enhanced PDCCH order initiating a random access procedure and indicating that the random access procedure is for timing advance, TA, acquisition only;
causing transmission of a random access preamble in a physical random access channel, PRACH, according to the enhanced PDCCH order;
monitoring a physical downlink shared channel, PDSCH, for information of a TA associated to the PRACH transmission; and
in response to receiving the TA carried in the PDSCH:
exiting the random access procedure; and
applying the TA to uplink transmissions associated to the TA.

29. The method of claim 28, wherein the enhanced PDCCH order indicates a contention free random access preamble.

30. The method of claim 28, wherein the exit of the random access procedure comprises considering that the random access procedure is successfully completed.

31. The method of claim 28, wherein the enhanced PDCCH order comprises a field that is configured to indicate whether the PDCCH order is for TA acquisition only.

32. The method of claim 28, wherein the enhanced PDCCH order comprises a field indicates a timing advanced group identifier, TAG ID.

33. The method of claim 28, wherein the TA is provided by a medium access control, MAC, control element, CE, carried in the PDSCH.

34.-39. (canceled)

40. The method of claim 28, further comprising, in response to the transmission of the random access preamble, starting a timer during which to monitor the PDSCH for information of the TA; and
if the TA is not received before expiration of the timer, causing retransmission of the random access preamble with a different transmit power from a previous transmit power for the random access preamble.

41. The method of claim 40, wherein the PDCCH order indicates a number of PRACH retransmissions allowed for acquiring the TA.

42. A method implemented by a network node that is in communication with a wireless device via at least a first transmission and reception point, TRP, the method comprising:
causing transmission, via the first TRP and to the wireless device, of an enhanced Physical Downlink Control Channel, PDCCH, order, the enhanced PDCCH order initiating a random access procedure and indicating that the random access procedure is for timing advance, TA, acquisition only;
receiving a random access preamble in a physical random access channel, PRACH, according to the enhanced PDCCH order; and
in response to receiving the random access preamble, causing transmission of a TA carried in a physical downlink shared channel, PDSCH, the TA configured to:
cause the wireless device to exit the random access procedure in response to receiving the TA carried in the PDSCH; and
be applied to uplink transmissions associated with the TA.

43. The method of claim 42, wherein the enhanced PDCCH order indicates a contention free random access preamble.

44. The method of claim 42, wherein the exit of the random access procedure comprises considering that the random access procedure is successfully completed.

45. The method of claim 42, wherein the enhanced PDCCH order comprises a field that is configured to indicate whether the PDCCH order is for TA acquisition only.

46. The method of claim 42, wherein the enhanced PDCCH order comprises a field indicates a timing advanced group identifier, TAG ID.

47.-53. (canceled)

54. The method of claim 42, wherein the PDCCH order indicates a number of PRACH retransmissions allowed for acquiring the TA.
